(19) United States
(12) Patent Application Publication
(10) Pub. No.: US 2003/0055740 A1
(43) Pub. Date: Mar. 20, 2003

(54) Sales method of photomask design data

(75) Inventor: Masayoshi Mori, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/218,489

(22) Filed: Aug. 15, 2002

(30) Foreign Application Priority Data
Sep. 18, 2001 (JP) 2001-282986(P)

(51) Int. Cl. G06F 17/60

(52) U.S. Cl. 705/26; 709/229

(57) ABSTRACT

A sales administration server receives mask design data, administration entrustment specification data of the mask design data and disclosure entrustment specification data related to the mask design data from a terminal of a design maker. Upon receipt of a request to disclose specification information from a terminal of a purchase-requesting maker, the sales administration server transmits the specification information to a terminal of the purchase-requesting maker based on the disclosure condition included in disclosure entrustment specification data. Upon receipt of purchase request specification data from a purchase-requesting maker, the sales administration server transmits the mask design data to a terminal of the maker specified in the purchase request specification data. Thus, a sales method of mask design data mediates sales of mask design data between a maker entrusting sales of mask design data and a maker wishing to purchase.

### BACKGROUND OF THE INVENTION

1. Field of the Invention

The present invention relates to a sales method to sell mask design data of a photomask that is used in the formation of circuitry on a wafer in the fabrication of a semiconductor device to a maker that wishes to purchase mask design data.

2. Description of the Background Art

The photomask employed in the formation of circuitry on a wafer is formed of a glass substrate of approximately 5 inches to 10 inches to which a circuit pattern is transferred. The circuit pattern on a wafer is obtained by selectively exposing a photoresist applied on the wafer using a photomask to form a resist pattern, and repeating the processes of impurity implantation, thin film formation and etching.

The mask design data for the purpose of producing a photomask is created by the design maker that carries out a series of development from semiconductor device product planning to functional designing, logic circuitry designing and layout designing of circuitry and wiring pattern on the wafer. The mask maker receives a request from a wafer maker that fabricates semiconductor chips to produce a photomask based on mask design data. The wafer maker purchases the photomask from the mask maker to form circuitry on wafers to fabricate semiconductor chips. The mask design maker and the wafer makers may be the same company.

Conventionally, mask design data is sold through cooperation as well as OEM (Original Equipment Manufacturing). Some design makers have expressed their needs to exploit existing mask design data of other organizations in order to reduce the design cost. Recently, the sales and purchase of mask design data have initiated between individual design makers that produce mask design data.

Before a photomask used in the actual wafer fabrication line is obtained in the purchase and sales of mask design data, various procedures are required between the makers of interest such as the conclusion of appropriate contracts, data transfer through a complicated path, notification of the fabrication specification to the mask maker, adjustment with respect to the fabrication conditions of the wafer maker at the mask maker side, and the like.

The presence of a retention service to keep the mask design data entrusted on behalf of the design maker is known. This system reflects the increase of the organization cost due to the greater amount of mask design data. However, most of the services are based on storage by unit of an external recording medium. In most cases, it is difficult to track the storage status.

The demand for the purchase of existing mask design data of other corporations is surging to the aim of reducing the design cost. However, at the current stage, the burden on time, man labor, and cost is great before the mask design data is actually available.

It is to be noted that the amount of mask design data is significant, reflecting the increased scale of integration. Some mask design data is as large as 10 giga bytes or more. Accordingly, the facility cost and administration cost to provide back up and administration of mask design data are placing a burden on the corporation that possesses mask design data. There is also the problem that sufficient maintenance of the mask design data cannot be provided.

The mask design data obtained from the design maker may be modified uniquely by the mask maker to correspond to the request from the wafer maker. If the know-how or critical information of the mask maker or wafer maker is included in the modified mask design data, there is the possibility that the relevant mask design data cannot be returned to the design maker of that mask design data from the standpoint of industrial secrecy. Thus, there is a problem that the design maker cannot conduct the sales of that mask design data and can no longer identify the storage status of the mask design data.

### SUMMARY OF THE INVENTION

In view of the foregoing, an object of the present invention is to provide a sales method of mask design data of a photomask, administering the mask design data in a centralized manner, and mediating the sales of mask design data between a maker entrusting the sales of mask design data and a maker wishing to purchase mask design data through a computer system.

Another object of the present invention is to provide a sales method storing and administering mask design data of large size and high administration cost in a centralized manner, and selling the stored mask design data through a computer system based on a sales entrustment from a maker entrusting storage of mask design data.

According to the present invention, a sales method of selling mask design data of a photomask, upon receiving a sales entrustment of mask design data to a maker wishing to purchase mask design data through a computer system, includes: a step of registering a maker that wishes to purchase mask design data on maker registration data, a step of determining whether the maker wishing to purchase mask design data satisfies a disclosure condition of specification information according to a disclose request of specification information on a photomask received from a terminal of the maker that wishes to purchase mask design data, a step of transmitting the specification information to the terminal of the maker that wishes to purchase mask design data when determination is made that the specification information can be disclosed to the maker that wishes to purchase mask design data based on the determination result, a step of receiving purchase request specification data indicating a request to purchase mask design data from the terminal of the maker wishing to purchase mask design data, and a step of transmitting mask design data to the terminal determined based on the purchase request specification data.

Preferably, the sales method further includes a step of receiving administration entrustment specification data that requests administration of mask design data from a terminal of a sales-entrusting maker that entrusts sales of mask design data, and a step of receiving mask design data under administration entrustment specified in the administration entrustment specification data from the terminal of the sales-entrusting maker and storing the same. In the step of transmitting the mask design data to the terminal determined based on the purchase request specification data, the stored mask design data is transmitted.

Preferably in the step of receiving mask design data under administration entrustment specified in the administration entrustment specification data from the terminal of the sales-entrusting maker and storing the same, mask design data is transferred through a communication network or a recording medium.

Preferably, the sales method further includes a step of receiving administration entrustment specification data including storage source information indicating the storage source of mask design data from the terminal of the sales-entrusting maker of mask design data. In the step of transmitting mask design data to the terminal determined based on the purchase request specification data, notification of a purchase application of mask design data is sent to a terminal of a storage source maker of the mask design data identified by the storage source information, and the mask design data is sent from the terminal of the storage source maker according to the notification.

Preferably, the sales method further includes a step of determining whether the maker wishing to purchase mask design data satisfies a sales condition of mask design data according to receipt of purchase request specification data from a terminal of the maker wishing to purchase mask design data. When determination is made that mask design data can be sold to the maker wishing to purchase mask design data based on that determination result, the mask design data is transmitted at the step of transmitting mask design data to the terminal determined based on the purchase request specification data.

Preferably in the step of transmitting mask design data to the terminal determined based on the purchase request specification data, mask design data is transmitted to the terminal of the maker designated by the transmission destination information included in the purchase request specification data.

According to the sales method of mask design data of a photomask of the present invention, sales of mask design data is mediated based on administration entrustment specification data, disclosure entrustment specification data or sales entrustment specification data received from a maker wishing to sell mask design data, and purchase request specification data received from a maker wishing to purchase mask design data. Therefore, the tedious sales procedure or purchase procedure is eliminated to allow each maker to suppress the sales cost and the time required for the sale procedure or purchase procedure.

Since the storage of mask design data of large size is effected in a centralized manner at the sales administration server, the maker owning mask design data can have the administration cost of mask design data reduced.

Disclosure of the specification information related to mask design data and the party to which mask design data is sold can be limited according to the request of the maker entrusting administration of mask design data. Therefore, the maker entrusting administration can prevent outflow of the know-how related to mask design data towards competent makers.

The sales commission fee and storage fee are lowered according to the number of sales and storing size of the mask design data under administration entrustment. Therefore, the maker entrusting administration of mask design data is motivated to entrust more mask design data. Accordingly, the maker entrusting administration of mask design data can reduce the administration cost of mask design data. Also, the administrator conducting administration of mask design data can collect more revenues of the administration fee and sales commission fee.

The foregoing and other objects, features, aspects and advantages,of the present invention will become more apparent from the following detailed description of the present invention when taken in conjunction with the accompanying drawings.

### BRIEF DESCRIPTION OF THE DRAWINGS

FIG. 1 is a schematic block diagram of an entire structure of a sales system of mask design data of a photomask according to the present invention.

FIG. 2 shows a structure of maker registration data organized in a sales administration server in the mask design data sales system of FIG. 1.

FIG. 3 shows a file structure of mask design data in the mask design data sales system of FIG. 1.

FIG. 4 shows a structure of administration entrustment specification data employed in the mask design data sales system of FIG. 1.

FIG. 5 shows a structure of disclosure entrustment specification data employed in the mask design data sales system of FIG. 1.

FIG. 6 shows a structure of sales entrustment specification data employed in the mask design data sales system of FIG. 1.

FIG. 7 shows a structure of sales request specification data employed in the mask design data sales system of FIG. 1.

FIG. 8 shows a structure of a maker registration table stored in the sales administration server of the mask design data sales system of FIG. 1.

FIG. 9 shows a structure of an administration entrustment specification data stored in the sales administration server in the mask design data sales system of FIG. 1.

FIG. 10 shows a structure of a disclosure entrustment specification table stored in the sales administration server in the mask design data sales system of FIG. 1.

FIG. 11 shows a structure of a sales entrustment specification table stored in the sales administration server in the mask design data sales system of FIG. 1.

FIG. 12 shows a structure of a purchase request specification table stored in the sales administration server in the mask design data sales system of FIG. 1.

FIG. 13 shows a structure of the sales administration server in the mask design data sales system of FIG. 1.

FIG. 14 shows a structure of an accounting table stored in the sales administration server in the mask design data sales system of FIG. 1.

FIG. 15 shows a structure of a storage fee account determination table stored in the sales administration server in the mask design data sales system of FIG. 1.

FIG. 16 shows a structure of a sales commission fee account determination table stored in the sales administration server in the mask design data sales system of FIG. 1.

FIG. 17 is a functional block of the sales administration server in the mask design data sales system of FIG. 1.

FIG. 18 is a flow chart to describe the process related to administration entrustment of mask design data in the mask design data sales system of FIG. 1.

FIG. 19 is a flow chart to describe the process related to disclosure entrustment of specification information related to mask design data in the mask design data sales system of FIG. 1.

FIG. 20 is a flow chart to describe the process related to disclosure of specification information related to mask design data in the mask design data sales system of FIG. 1.

FIG. 21 is a flow chart to describe the process related to sales entrustment of mask design data in the mask design data sales system of FIG. 1.

FIGS. 22 and 23 are a first flow chart and a second flow chart, respectively, to describe a process related to sales of mask design data in the mask design data sales system of FIG. 1.

FIG. 24 is a flow chart to describe a process related to accounting in the mask design data sales system of FIG. 1.

FIG. 25 shows a list of the process that can be carried out by each terminal with respect to the sales administration server in the mask design data sales system of FIG. 1.

FIG. 26 shows another structure of administration entrustment specification data employed in the mask design data sales system of FIG. 1.

FIG. 27 shows another structure of an administration entrustment specification table stored in the sales administration server in the mask design data sales system of FIG. 1.

FIG. 28 is a flow chart to describe another process related to administration entrustment of mask design data in the mask design data sales system of FIG. 1.

FIG. 29 is a flow chart to describe another process related to disclosure entrustment of specification information related to mask design data in the mask design data sales system of FIG. 1.

FIGS. 30 and 31 are a first flow chart and a second flow chart, respectively, to describe another process related to sales of mask design data in the mask design data sales system of FIG. 1.

### DESCRIPTION OF THE PREFERRED EMBODIMENTS

Embodiments of the present invention will be described hereinafter with reference to the drawings. In the drawings, the same or corresponding components have the same reference characters allotted, and description thereof will not be repeated.

First Embodiment

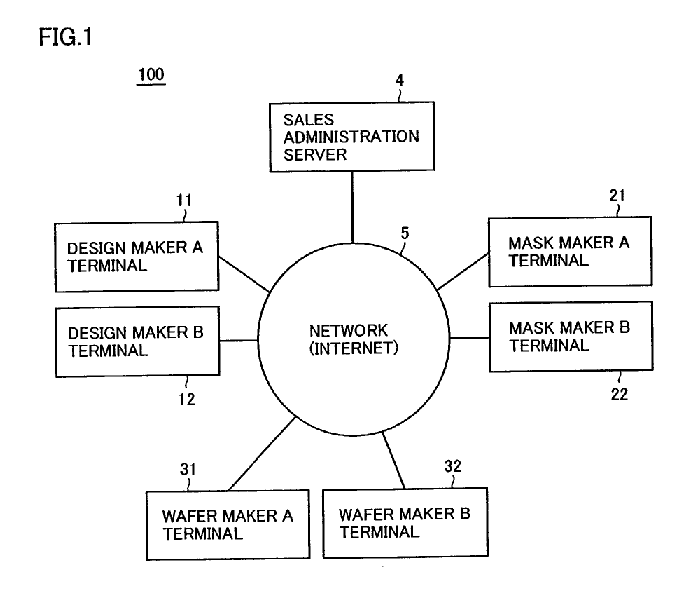

FIG. 1 shows an entire structure of a sales system of mask design data of a photomask of the present invention.

Referring to FIG. 1, a mask design data sales system 100 includes design maker terminals 11 and 12, mask maker terminals 21, 22, wafer maker terminals 31 and 32, a sales administration server 4, and a network 5. Design maker terminals 11 and 12, mask maker terminals 21 and 22, wafer maker terminals 31 and 32, and sales administration server 4 are connected to each other via network 5.

Design maker terminals 11 and 12 are terminals of design makers that design a semiconductor device to produce mask design data of a photomask to form circuitry on a wafer. The design maker plans a product of a semiconductor device, designs logic circuitry, and designs the circuit layout on the wafer to produce the mask design data of a photomask. Generally, a plurality of design maker terminals 11 and 12 are connected onto network 5 corresponding to the number of design makers utilizing mask design data sales system 100.

A design maker A that is the user of design maker terminal 11 entrusts administration and sales of mask design data to sales administration server 4. Design maker A produces administration entrustment specification data to entrust administration of mask design data to sales administration server 4. Design maker terminal 11 transmits the mask design data that is the subject of entrustment and the administration entrustment specification data to sales administration server 4 via network 5.

Design maker A also produces disclosure entrustment specification data including specification information related to mask design data that is the subject of administration entrustment, the disclosure condition of the specification information, and the like. Design maker terminal 11 transmits the disclosure entrustment specification data to sales administration server 4 via network 5.

Design maker A further produces sales entrustment specification data including the sales condition of mask design data. Design maker terminal 11 transmits the sales entrustment specification data to sales administration server 4 via network 5. The administration entrustment specification data, disclosure entrustment specification data and sales entrustment specification data will be described in detail afterwards.

Mask maker terminals 21 and 22 are the terminals of mask makers that fabricate a photomask from the mask design data produced by a design maker. Generally a plurality of mask maker terminals 21 and 22 are connected onto network 5 corresponding to the number of mask makers utilizing mask design data sales system 100.

Wafer maker terminals 31 and 32 are terminals of wafer makers fabricating a semiconductor chip using the photomask fabricated by the mask maker. The wafer maker transmits the purchased mask design data to the mask maker to entrust fabrication of a photomask, and then obtains the photomask from the mask maker. The wafer maker forms a circuit pattern on the wafer using the obtained photomask in the lithography process. The wafer is subjected to other processes to be eventually produced as a semiconductor chip. Generally a plurality of wafer maker terminals 31 and 32 are connected onto network 5 corresponding to the number of wafer makers utilizing mask design data sales system 100.

Wafer maker A that is the user of wafer maker terminal 31 sends a request from wafer maker terminal 31 to sales administration server 4 via network 5 so as to disclose the specification information related to mask design data. Wafer maker terminal 31 receives the disclosed specification information from sales administration server 4 via network 5.

Upon receipt of the specification information at wafer maker terminal 31, wafer maker A selects the desired mask design data based on the received specification information and produces purchase request specification data requesting purchase of that mask design data. The purchase mask specification data will be described in detail afterwards. Wafer maker terminal 31 transmits the purchase request specification data to sales administration server 4 via network 5. The purchased mask design data is transmitted via network 5 from sales administration server 4 to mask maker terminal 21 of mask maker A that fabricates photomasks based on the purchase request specification data.

Sales administration server 4 functions to store mask design data received from design maker terminal 11 via network 5, and mediates the sales of mask design data between design maker A entrusting sales of mask design data and wafer maker A that wishes to purchase mask design data. Sales administration server 4 assigns a maker code and a password to design maker A and wafer maker A utilizing mask design data sales system 100, and registers the same on the maker registration data for administration.

Sales administration server 4 receives and administers administration entrustment specification data, disclosure entrustment specification data and sales entrustment specification data from design maker terminal 11. Sales administration server 4 also receives and stores mask design data from design maker terminal 11.

Furthermore, sales administration server 4 receives a disclose request of specification information related to mask design data from wafer maker terminal 31, determines whether specification information can be disclosed or not, and transmits the specification information to wafer maker terminal 31.

Sales administration server 4 also receives and administers the purchase request specification data from wafer maker terminal 31, determines whether the sales of mask design data to wafer maker A is allowed or not, and transmits, when allowed, the mask design data which is the subject of purchase.

Sales administration server 4 also determines the storage fee of mask design data for design maker A in accordance with to the storing size of mask design data. Specifically, in order to promote the receipt of more mask design data storage entrustments, sales administration server 4 reduces the unit cost of the storage fee as a function of a greater amount of a stored mask design data.

Sales administration server 4 also determines the sales commission fee of mask design data for design maker A in accordance with the number of sales of the mask design data. Specifically, in order to promote the receipt of storage entrustments, sales administration server 4 reduces the unit cost of the sales commission fee as a function of the number of sales of the mask design data.

Network 5 is a data communication network such as the Internet.

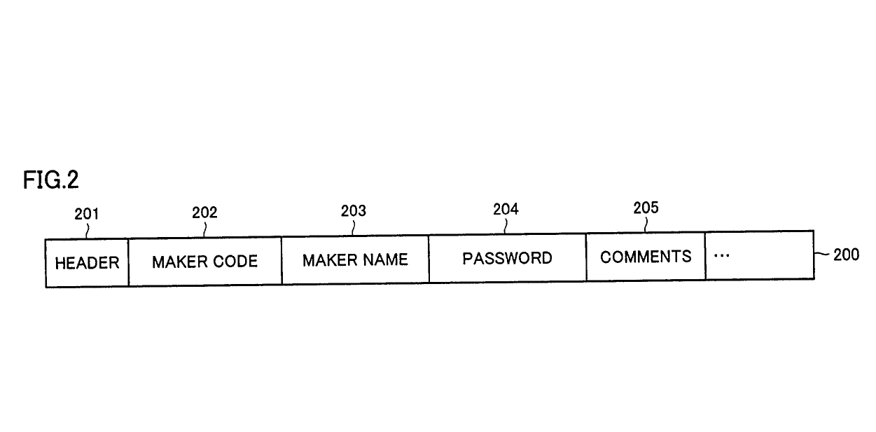

FIG. 2 shows a structure of maker registration data 200 created at sales administration server 4 corresponding to makers that utilize mask design data sales system 100.

Referring to FIG. 2, maker registration data 200 includes a header 201, a maker code 202, a maker name 203, a password 204, and comments 205. Header 201 includes information to recognize that the present data is maker registration data 200 as well as information such as the created date of the present data. Maker code 202 and password 204 are data assigned to each maker to identify respective makers. Maker name 203 is the designation of the registered maker. Comments 205 include data related to comments from the maker that wishes to be registered.

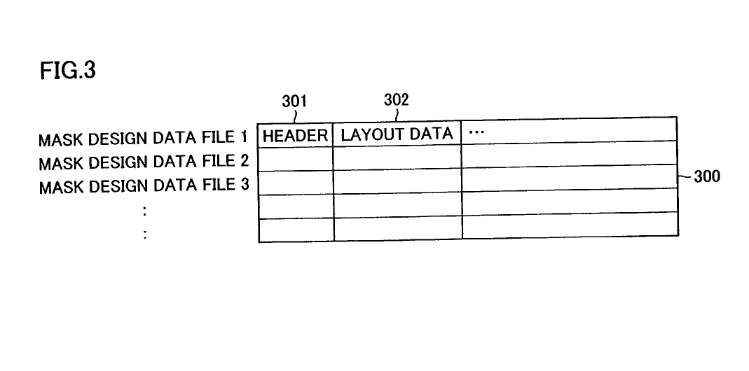

FIG. 3 shows a structure of mask design data 300, which is the subject of administration entrustment, transmitted from design maker terminal 11 to sales administration server 4 via network 5. In general, a plurality of photomasks are used to form circuitry on a wafer. Therefore, mask design data 300 includes a plurality of mask design data files corresponding to the number of photomasks. Each mask design data file includes a header 301, layout data 302, and the like. Header 301 includes information to recognize that the present data is a mask design data file, and information such as the created date of the present data. Layout data 302 includes the layout data of each circuit in one photomask.

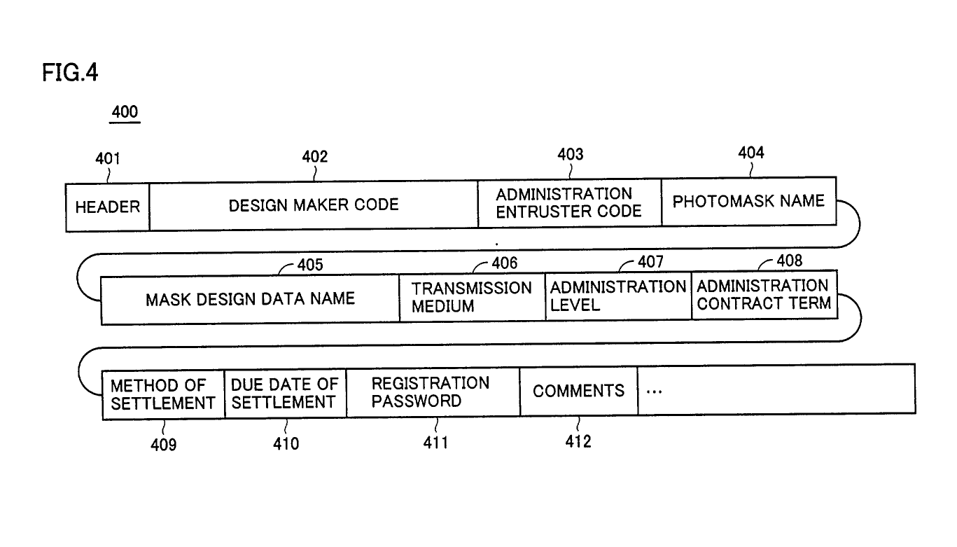

FIG. 4 shows a structure of administration entrustment specification data 4 produced by design maker A that is the user of design maker terminal 11 to entrust administration of mask design data 300 to sales administration server 4.

Referring to FIG. 4, administration entrustment specification data 400 includes a header 401, a design maker code 402, an administration entruster code 403, a photomask name 404, a mask design data name 405, a medium 406 for transmission, an administration level 407, an administration contract term 408, a settlement method 409, a settlement due date 410, a registration password 411 and comments 412.

Header 401 includes information to recognize that the present data is administration entrustment specification data 400 and information such as the created date of the present data. Design maker code 402 is the code of design maker A that has designed mask design data 300 which is the subject of administration entrustment. Administration entruster code 403 is the code of the maker that has entrusted administration of mask design data 300, and is the code of design maker A. Photomask name 404 is the designation of the photomask fabricated according to mask design data 300 which is the subject of administration entrustment. Mask design data name 405 is the file name of mask design data 300 which is the subject of administration entrustment. Transmission medium 406 is the data designating the medium for transmission of mask design data 300 from design maker terminal 11 to sales administration server 4 in the entrustment of administration of mask design data 300. The data of transmission medium 406 indicates whether transmission is effected via network 5 or by a recording medium or the like.

The data of administration level 407 is related to the administration level of mask design data 300 which is the subject of administration entrustment. For example, administration level 407 includes data related to the security level such as whether strict administration of mask design data 300 is desired or whether accidental erasure is admissible or not, or data related to the access speed towards mask design data 300 (for example, storage in a disk device that allows immediate output, or storage in an external recording medium such as the recording tape from the standpoint of reducing the administration cost even if the time for access is slightly degraded), and the like.

The data of administration contract term 408 designates the administration period of mask design data 300 which is the subject of administration entrustment. The data of settlement method 409 is related to the method of settling the payment for the purchasing maker that has purchased mask design data 300. The data of settlement due date 410 is related to the due date of settling the payment with respect to the maker that has purchased mask design data 300. Registration password 411 is a password assigned in the contract of storage entered in advance between the organization that supervises sales administration server 4 and design maker A prior to an administration entrustment through administration entrustment specification data 400. Comments 412 are the data related to comments from design maker A.

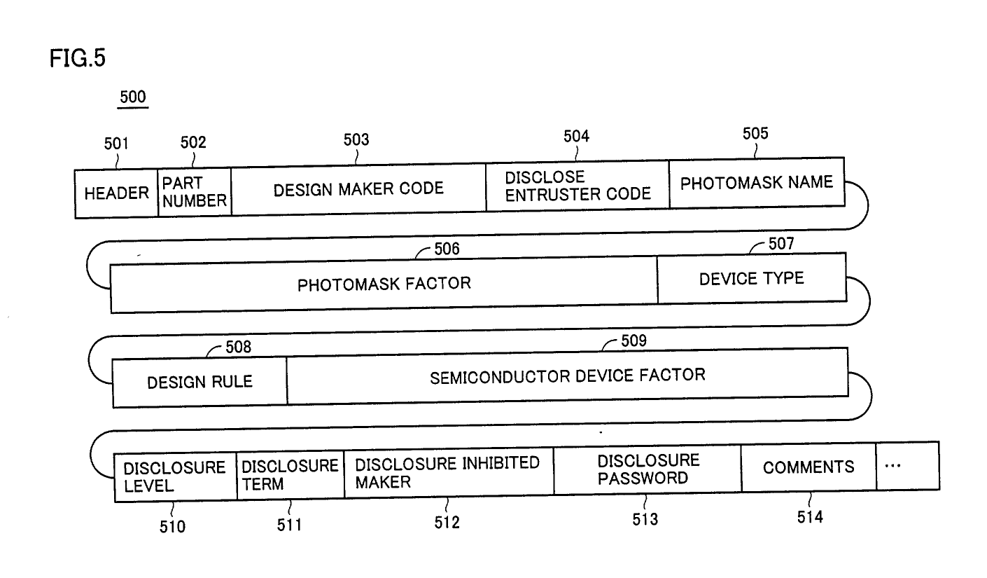

FIG. 5 shows a structure of disclosure entrustment specification data 500 produced and sent from design maker A to sales administration server 4 so as to entrust disclosure of the specification information related to mask design data 300.

Referring to FIG. 5, disclosure entrustment specification data 500 includes a header 501, a product number 502, a design maker code 503, a disclose entruster code 504, a photomask name 505, a photomask factor 506, a device type 507, a design rule 508, a semiconductor device factor 509, a disclosure level 510, a disclosure term 511, a disclose inhibited maker 512, a disclosure password 513 and comments 514.

Header 501 includes information to recognize that the present data is disclosure entrustment specification data 500, and information such as the created date of the present data. Product number 502 is assigned when administration of mask design data 300 is entrusted, and is the number of mask design data 300 corresponding to disclosure entrustment specification data 500. Design maker code 503 is the code of design maker A that has designed mask design data 300 corresponding to disclosure entrustment specification data 500. Disclose entruster code 504 is the code of the maker that has entrusted disclosure of mask design data 300, and is the code of design maker A. Photomask name 505 is the designation of the photomask fabricated based on mask design data 300.

Photomask factor 506 is the data related to the specification of the photomask fabricated based on mask design data 300. For example, photomask factor 506 includes the data of the substrate size of the photomask, the film quality, the element dimension accuracy, the element phase accuracy, defect/foreign particle level, transmittance, phase angle, and the like.

The data of device type 507 indicates the type of the device produced using the photomask, and includes the data of “DRAM”, “SRAM”, for example. Design rule 508 includes data related to the design rule of the circuitry and wiring determined by the fabrication condition.

Semiconductor device factor 509 is the specification data of the semiconductor device generated using the photomask fabricated based on mask design data 300, and includes data of, for example, the driving voltage of the fabricated semiconductor device, the memory capacity, the operating frequency, the type of package, and the like. When a request of specification information disclosure is issued from wafer maker terminal 31 of the maker wishing to purchase mask design data, sales administration server 4 transmits and discloses the aforementioned data of photomask name 505, photomask factor 506, device type 507, design rule 508, and semiconductor device factor 509 to wafer maker terminal 31, provided that the disclosure condition described afterwards is satisfied.

The data of disclosure level 510 relates to the level of disclosing each specification data included in photomask factor 506 and semiconductor device factor 509. By presetting the disclosure level of each specification data and including the set disclosure level in disclosure level 510, only the specification data corresponding to the appropriate disclosure level is disclosed. For example, in photomask factor 506, the substrate size and film quality are set to disclosure level 1, and the other factor data are set to disclosure level 2. In semiconductor device factor 509, all the specification data are set to disclosure level 1. In the case where design maker A has “1” set for disclosure level 510, the specification data having the disclosure level set to 1 is disclosed. When “2” is set, the specification data having the disclosure level set to 1 and 2 are disclosed. Also, by setting the maker of interest of disclosure and the disclosure level in disclosure level 510, the disclosure level for each specification data can be changed according to the maker of interest of disclosure.

The data of disclosure term 511 designates the disclosure term of the specification information. Disclosure inhibited maker 512 is the code of the maker to which disclose of the specification information is inhibited so that design maker A can restrict the maker to which the specification information is to be disclosed. Sales administration server 4 will not transmit specification information of mask design data 300 to any maker registered in the list of disclosure inhibited maker 512. Disclosure password 513 is a password assigned in advance when a contract is entered between the organization supervising sales administration server 4 and design maker A, prior to disclosure entrustment through disclosure entrustment specification data 500. Comments 514 are the data related to comments from design maker A.

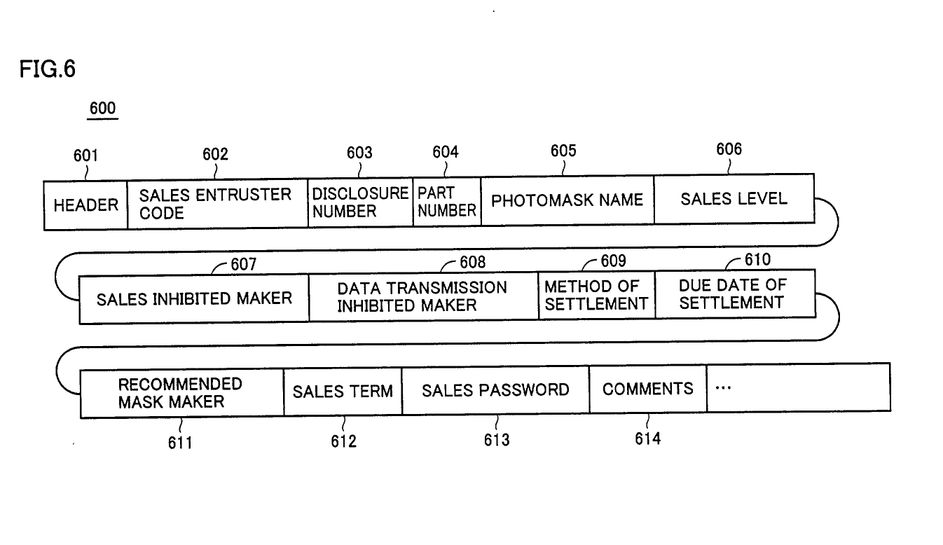

FIG. 6 shows a structure of sales entrustment specification data 600 produced by design maker A to sales administration server 4 to entrust sales of mask design data 300.

Referring to FIG. 6, sales entrustment specification data 600 includes a header 601, a sales entruster code 602, a disclosure number 603, a product number 604, a photomask name 605, a sales level 606, a sales inhibited maker 607, a data transmission inhibited maker 608, a settlement method 609, a settlement due date 610, a recommended mask maker 611, a sales term 612, a sales password 613 and comments 614.

Header 601 includes information to recognize that the present data is sales entrustment specification data 600 and information such as the created date of the present data. Sales entruster code 602 indicates the maker entrusting sales of mask design data 300, and is the code of design maker A. Disclosure number 603 is assigned when a disclose entrustment is effected on mask design data 300, and is the notified number sent from sales administration server 4 to design maker terminal 11. Design maker A must enter the disclosure number corresponding to mask design data 300 that is a subject of sales entrustment as disclosure number 603. Product number 604 is assigned when administration of mask design data 300 is entrusted, and specifies mask design data 300 corresponding to sales entrustment specification data 600. Photomask name 605 is the designation of the photomask fabricated based on mask design data 300.

Sale level 606 indicates whether an aggressive sales activity is to be effected or not. For example, a sales level is predetermined such as whether sales is to be promoted by sending a direct mail and the like to respective makers registered in maker registration data 200, or not (i.e., aggressive sale is not particularly effected) such as in the case where storage is mainly the object. Design maker A can set a desired level for sales level 606.

Sales inhibited maker 607 indicates the code of the maker to which sales of mask design data 300 is inhibited. The maker whose name is included as this sales inhibited maker 607 cannot purchase mask design data 300 even if a purchase request is issued.

Data transmission inhibited maker 608 designates the code of the maker inhibited of transmission of mask design data 300. For example, consider the case where design maker A does not want to sell mask design data 300 to a competent design maker B. The case may be expected where mask design data 300 can be transmitted from wafer maker terminal 31 of wafer maker A that has purchased mask design data 300 to design maker terminal 12 of design maker B. The designation of data transmission inhibited maker 603 is provided to prevent such a case. The maker whose code is included in the list of data transmission inhibited maker 608 cannot obtain mask design data 300 even if that maker is specified as the transmission destination of mask design data 300.

Settlement method 609 includes data related to the method of settling the payment for the maker that has purchased mask design data 300. Settlement due date 610 includes data related to the due date of settling the payment for the maker that has purchased mask design data 300. Recommended mask maker 611 includes the code of the mask maker recommended for the usage of mask design data 300 that is the subject of sales entrustment to fabricate a photomask. The data of sales term 612 designates the sales term of mask design data 300 that is the subject of sales entrustment. Sales password 613 is assigned in the contract entered between the organization supervising sales administration server 4 and design maker A, prior to a sales entrustment by sales entrustment specification data 600. Comments 614 are the data related to the comments from design maker A.

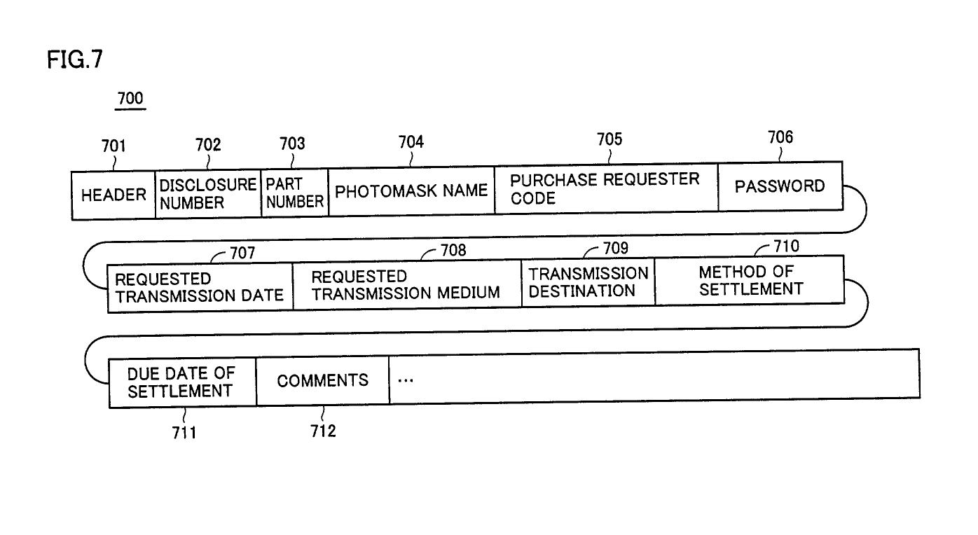

FIG. 7 shows a structure of purchase request specification data 700 produced by wafer maker A to request purchase of mask design data 300 to sales administration server 4.

Referring to FIG. 7, purchase request specification data 700 includes a header 701, a disclosure number 702, a product number 703, a photomask name 704, a purchase requester code 705, a password 706, a requested transmission date 707, a requested transmission medium 708, a transmission destination 709, a settlement method 710, a settlement due date 711, and comments 712.

Header 701 includes information to recognize that the present data is purchase request specification data 700 and information such as the created date of the present data. Disclosure number 702 is assigned by sales administration server 4 when disclosure entrustment for mask design data 300 is effected with sales administration server 4. Wafer maker A is notified of this disclosure number when the specification information is disclosed upon a request to disclose specification information to sales administration server 4 prior to a purchase request. Product number 703 indicates mask design data 300 which is the subject of purchase. Wafer maker A is notified of the product number of mask design data 300 when the specification information is disclosed, similarly as the disclosure number. Photomask name 704 is the designation of the photomask that is fabricated using mask design data 300. Purchase requester code 705 is the code of the maker requesting purchase of mask design data 300, and is assigned to wafer maker A. Password 706 is a password assigned to wafer maker A. Requested transmission date 707 is the desired date of delivery of mask design data 300. The data of requested transmission media 708 designates whether delivery of mask design data 300 is effected via network 5 or by a recording medium.

Transmission destination 709 indicates the code of a mask maker, mask maker A here, specified as the destination of transferring the purchase mask design data 300. Based on transmission destination 709, sales administration server 4 transmits the purchased mask design data 300 to mask maker terminal 21 of mask maker A via network 5.

The data of settlement method 710 is related to the method of settlement in the purchase of mask design data 300. The data of settlement due date 711 is related to the due date of settlement in the purchase of mask design data 300. Comments 712 are the data related to the comments from the maker that wishes to purchase mask design data.

Referring to FIG. 1 again, design maker terminal 11 attaches mask design data 300 that is the subject of administration entrustment to administration entrustment specification data 400 and transmits the data to sales administration server 4 via network 5. In the transmission of mask design data 300, design maker A takes into account the data size and the security of mask design data 300 that is the subject of administration entrustment. When a recording medium is specified as the medium for transmission in transmission medium 406 in administration entrustment specification data 400, mask design data 300 is recorded in a recording medium and then sent to the administrator of sales administration server 4. Mask design data 300 is read into sales administration server 4 by the administrator.

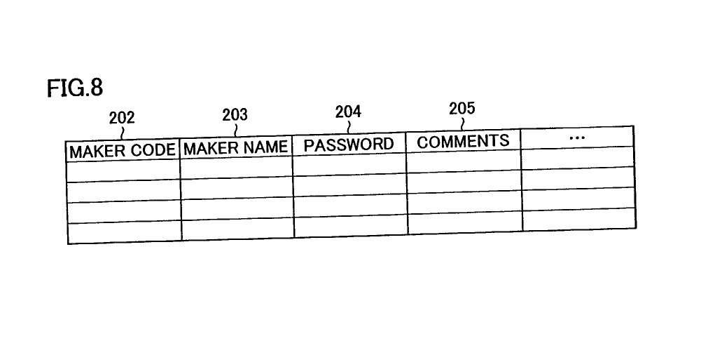

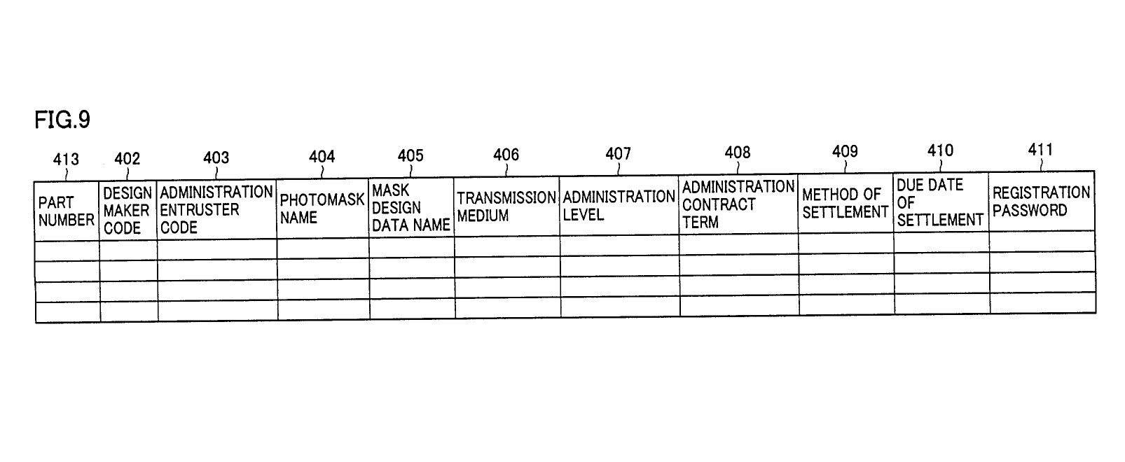

Upon receiving administration entrustment specification data 400, sales administration server 4 produces maker registration data 200 corresponding to design maker A from which administration entrustment specification data 400 has been transmitted, if that design maker A is not yet registered, and stores the produced maker registration data 200 in a maker registration table shown in FIG. 8. Sales administration server 4 transmits maker registration data 200 corresponding to design maker A, when produced, to design maker terminal 11 via network 5, and prompts design maker A to enter maker code 202 included in the transmitted maker registration data 200 and send back the completed administration entrustment specification data 400 again. Upon receiving administration entrustment specification data 400 recorded with maker code 202 from design maker terminal 11, sales administration server 4 assigns a product number 413 and stores the same in an administration entrustment specification table shown in FIG. 9.

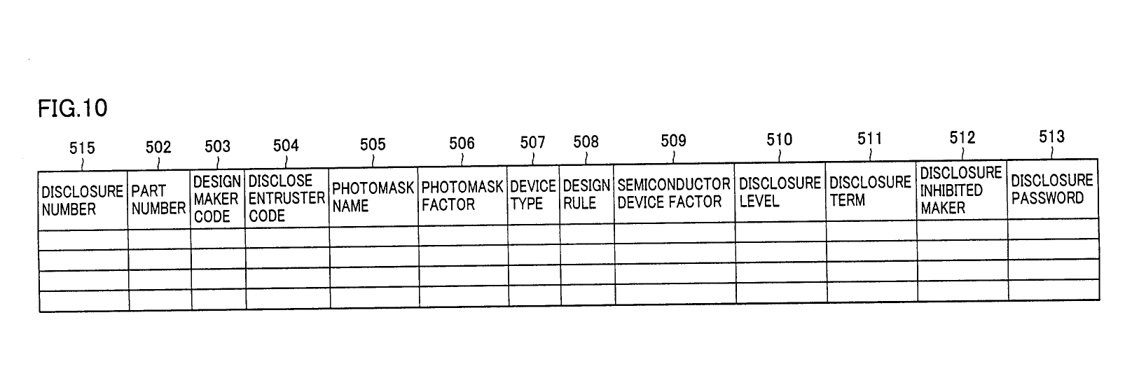

Then, design maker terminal 11 transmits disclosure entrustment specification data 500 corresponding to mask design data 300 of interest to sales administration server 4 via network 5. Upon receiving disclosure entrustment specification data 500, sales administration server 4 assigns a disclosure number 515 and stores the same in a disclosure entrustment specification table shown in FIG. 10.

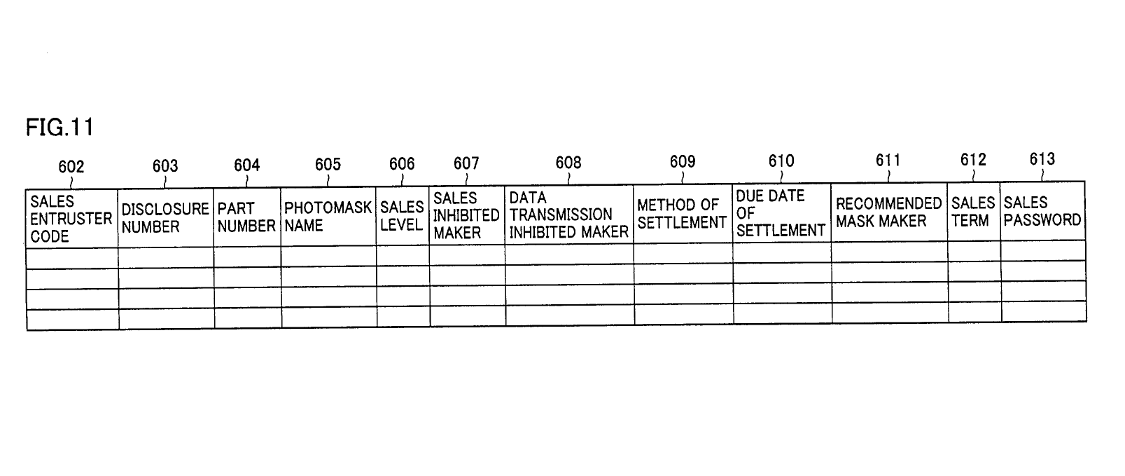

Then, design maker terminal 11 transmits sales entrustment specification data 600 corresponding to mask design data 300 that is the subject of disclosure entrustment to sales administration server 4 via network 5. Upon receiving sales entrustment specification data 600, sales administration server 4 stores the same in a sales entrustment specification table shown in FIG. 11.

Wafer maker terminal 31 sends a request to sales administration server 4 via network 5 to disclose the specification information related to mask design data 300 administered by sales administration server 4 in the process of purchasing mask design data 300. Upon receiving a disclose request specification information, sales administration server 4 searches for disclosure entrustment specification data 500 matching the request from the disclosure entrustment specification table. Based on the disclosure conditions such as disclosure inhibited maker 512 and disclosure term 511, determination is made whether the specification information can be disclosed to wafer maker A that has issued the disclose request. When determination is made that the specification information can be disclosed, sales administration server 4 transmits the specification data of photomask name 505, photomask factor 506, device type 507, design rule 508, and semiconductor device factor 509 based on disclosure level 510 to wafer maker terminal 31 via network 5.

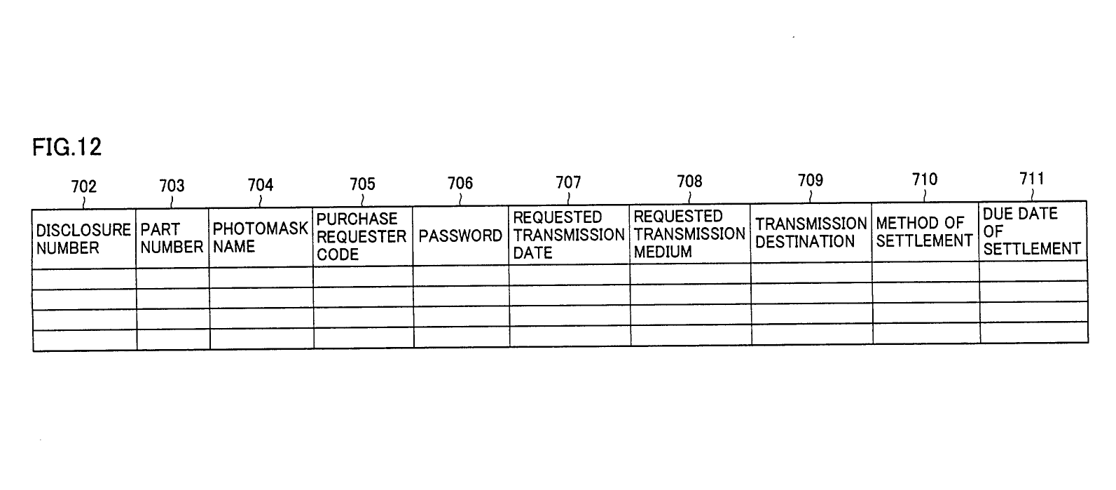

Wafer maker A selects an appropriate photomask from the received specification information to transmit purchase request specification data 700 to sales administration server 4 from wafer maker terminal 31 via network 5. Sales administration server 4 receives and stores purchase request specification data 700 in the purchase request specification table shown in FIG. 12. Then, sales administration server 4 obtains sales entrustment specification data 600 corresponding to mask design data 300 that is the subject of purchase from the sales entrustment specification table to determine whether mask design data 300 that is the subject of purchase can be sold to wafer maker A based on the sales conditions such as sales inhibited maker 607 and sales term 612. When determination is made that sales of mask design data 300 is allowed, sales administration server 4 transmits mask design data 300 to mask maker terminal 21 of mask maker A designated in transmission destination 709 through the specified medium on the specified date based on the data of requested transmission date 707 and requested transmission medium 708 included in purchase request specification data 700.

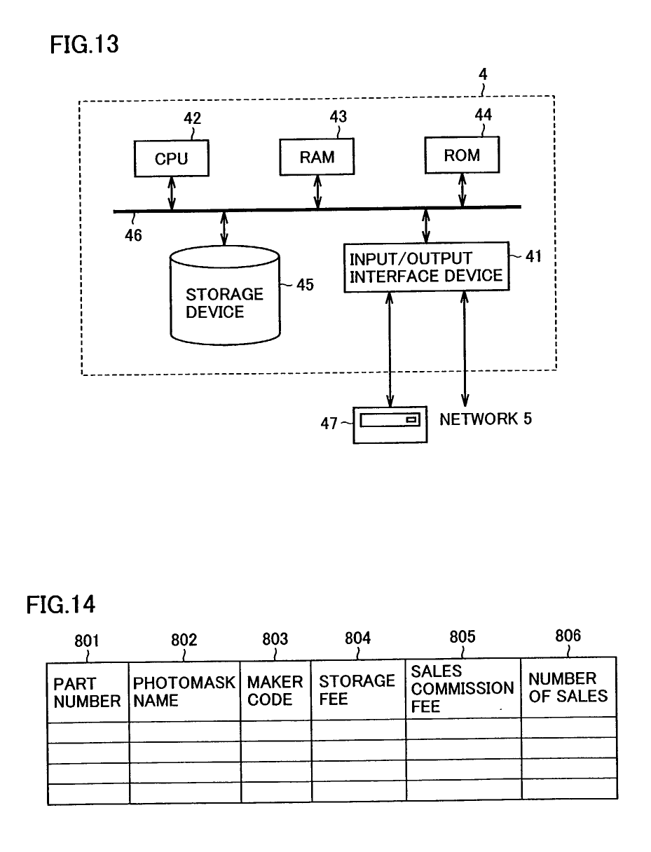

The structure of sales administration server 4 storing and administering the sales of mask design data will be described with reference to FIG. 13. Sales administration server 4 includes an input/output interface device 41, a CPU (Central Processing Unit) 42, a RAM (Random Access Memory) 43, a RAM (Read Only Memory) 44, a storage device 45 and a bus 46. Sales administration server 4 has a recording medium control device 47 connected.

Input/output interface device 41 effects data transfer from/to sales administration server 4 to/from network 5 and recording medium control device 47.

For the registration of various makers utilizing mask design data sales system 100, CPU 42 issues a maker code and password to produce maker registration data 200. Maker registration data 200 is stored in storage device 45. CPU 42 also has administration entrustment specification data 400, mask design data 300, disclosure entrustment specification data 500, sales entrustment specification data 600 and purchase request specification data 700 stored in storage device 45, received through input/output interface device 41. CPU 42 also determines whether the specification information included in disclosure entrustment specification data 500 is to be disclosed or not, determines whether mask design data 300 is to be sold or not, and designates transmission of mask design data 300.

RAM 43 is the work memory for the operation of CPU 42.

ROM 44 is the memory where the execution program and the like of CPU 42 is stored.

Storage device 45 stores maker registration data 200, administration entrustment specification data 400, mask design data 300, disclosure entrustment specification data 500, sales entrustment specification data 600 and purchase request specification data 700. Since some mask design data 300 are as large as 10 giga bytes or more in data size, a storage device capable of storing data of a large amount is employed for storage device 45. Storage device 45 is, for example, an HD (Hard Disk) of large storage capacity, an external recording tape, a CD (Compact Disk), a DVD (Digital Video Disk), or the like.

Bus 46 is the communication path of data transferred between respective devices of input/output interface device 41, CPU 42, RAM 43, ROM 44 and storage device 45.

Recording medium control device 47 reads/writes mask design data 300 from/to a recording medium in the case where mask design data 300 is to be transferred via a recording medium.

When administration entrustment specification data 400 is received at input/output interface 41 from network 5 in sales administration server 4, CPU 42 writes the received administration entrustment specification data 400 into RAM 43. CPU 42 reads out the maker code of administration entruster code 403 in administration entrustment specification data 400 from RAM 43 to check the presence of maker registration data 200 corresponding to design maker A that is the entruster of administration. If maker registration data 200 for design maker A is not present, CPU 42 produces maker registration data 200 corresponding to design maker A, and instructs input/output interface device 41 to transmit the generated maker registration data 200 to design maker terminal 11 that is the terminal of the transmission source of administration entrustment specification data 400. Input/output interface device 41 transmits the relevant maker registration data 200 to design maker terminal 11 via network 5.

Upon receipt of mask design data 300 attached to administration entrustment specification data 400 from network 5 or recording medium control device 47 at input/output interface device 41, CPU 42 writes the received mask design data 300 into RAM 43. CPU 42 reads out mask design data 300 and administration entrustment specification data 400 corresponding to that mask design data 300 to provide the same to storage device 45 from RAM 43. Storage device 45 stores mask design data 300 as well as administration entrustment specification data 400 in the administration entrustment specification table.

Upon receipt of disclosure entrustment specification data 500 from network 5 at input/output interface device 41, CPU 42 writes the received disclosure entrustment specification data 500 into RAM 43. CPU 42 reads out the maker code of disclose entruster code 504 included in disclosure entrustment specification data 500 from RAM 43 to check whether there is maker registration data 200 corresponding to design maker A that has entrusted disclosure. CPU 42 produces maker registration data 200 corresponding to design maker A, if not yet registered, and instructs input/output interface device 41 to transmit the produced maker registration data 200 to design maker terminal 11 that is the terminal of the transmission source of disclosure entrustment specification data 500. Input/output interface device 41 transmits maker registration data 200 to design maker terminal 11 via network 5. CPU 42 assigns a disclosure number 515 into the received disclosure entrustment specification data 500 and provides the same to storage device 45. Storage device 45 stores disclosure entrustment specification data 500 in the disclosure entrustment specification table.

Upon receipt of sales entrustment specification data 600 from network 5 at input/output interface device 41, CPU 42 writes sales entrustment specification data 600 into RAM 43. CPU 42 reads out the maker code of sales entruster code 602 in sales entrustment specification data 600 from RAM 43 to check whether there is maker registration data 200 corresponding to that design maker A that is the entruster of sales. CPU 42 produces maker registration data 200 of design maker A, when not yet registered, and instructs input/output interface device 41 to transmit the produced maker registration data 200 to design maker terminal 11 that is the terminal of the transmission source of sales entrustment specification data 600. Accordingly, input/output interface device 41 transmits maker registration data 200 to design maker terminal 11 via network 5. CPU 42 provides sales entrustment specification data 600 to storage device 45. Storage device 45 stores the received sales entrustment specification data 600 in the sales entrustment specification table.

Upon receipt of a specification information disclose request related to mask design data 300 at input/output interface device 41, CPU 42 searches for disclosure entrustment specification data 500 matching the specification information that is requested for disclosure from storage device 45. The relevant disclosure entrustment specification data 500 is read out and written into RAM 43. CPU 42 checks whether wafer maker A that is the maker of the transmission source of the disclose request satisfies the disclosure condition of not being included in the list of disclosure inhibited maker 512. When determination is made that wafer maker A satisfies the disclosure condition, CPU 42 instructs input/output interface device 41 to transmit to wafer maker terminal 31 the specification data of photomask name 505, photomask factor 506, device type 507, design rule 508 and semiconductor device factor 509 based on disclosure level 510. Accordingly, input/output interface device 41 transmits the various specification data to wafer maker terminal 31 that is the transmission source of the disclose request via network 5.

Upon receipt of purchase request specification data 700 from network 5 at input/output interface device 41, CPU 42 writes purchase request specification data 700 into RAM 43. CPU 42 reads out the maker code of purchase requester code 705 included in purchase request specification data 700 from RAM 43 and checks whether maker registration data 200 corresponding to that wafer maker A requesting purchase of mask design data is present or not. CPU 42 produces maker registration data 200 corresponding to wafer maker A, when not yet registered, and instructs input/output interface device 41 to transmit the generated maker registration data 200 to wafer maker terminal 31 that is a terminal of the transmission source of purchase request specification data 700. Accordingly, input/output interface device 41 transmits maker registration data 200 to wafer maker terminal 31 via network 5. CPU 42 searches for sales entrustment specification data 600 corresponding to mask design data 300 based on product number 703 in purchase request specification data 700 from storage device 45. The appropriate sales entrustment specification data 600 is read out and written into RAM 43.

CPU 42 checks the sales condition such as whether the maker code of purchase requester code 705 is not designated in sales inhibited maker 607 and whether sales term 612 is satisfied based on purchase request specification data 700 and sales entrustment specification data 600. When determination is made that wafer maker A that is the transmission source of purchase request specification data 700 satisfies the sales condition, CPU 42 checks whether the maker code of transmission destination 709 is not listed in data transmission inhibited maker 608. When determination is made that transmission is allowed, CPU 42 instructs input/output interface device 41 to transmit mask design data 300 to mask maker terminal 21 specified by the maker code of transmission destination 709 by the medium specified at requested transmission medium 708 at the date requested in requested transmission date 707.

In the case where the requested transmission medium is network 5, input/output interface device 41 transmits mask device data 300 to mask maker terminal 21 via network 5. When the desired transmission medium is a recording medium, CPU 42 transmits mask design data 300 to recording medium control device 47 based on the designation of the administrator of sales administration server 4. Recording medium control device 47 records mask design data 300 in a recording medium, which is transferred to mask maker A. CPU 42 outputs purchase request specification data 700 to storage device 45. Storage device 45 stores purchase request specification data 700 into the purchase request specification table.

Upon receipt of administration entrustment specification data 400, CPU 42 also generates an accounting table shown in FIG. 14.

Referring to FIG. 14, the accounting table includes a product number 801, a photomask name 802, a maker code 803, a storage fee 804, a sales commission fee 805, and the number of sales 806. Product number 801 is the number assigned to mask design data 300 that is the subject of administration entrustment. Photomask name 802 is the designation of the photomask fabricated by mask design data 300 that is the subject of administration entrustment. Maker code 803 is the code of design maker A that has entrusted administration of mask design data 300. Storage fee 804 is the fee to store mask data 300. When the accounting table is first generated, the storage fee will be set to a predetermined initial fee. However, the storage fee is altered depending upon the storage amount of mask design data 300, as will be described afterwards. Sales commission fee 805 is the fee of mediating the sales of mask design data 300. Similarly to storage fee 804, the sales commission fee is set to a predetermined initial fee when the accounting table is produced. The commission fee is altered depending upon the number of sales of mask design data 300, as will be described afterwards. The number of sales 806 indicates the number of sales of mask design data 300.

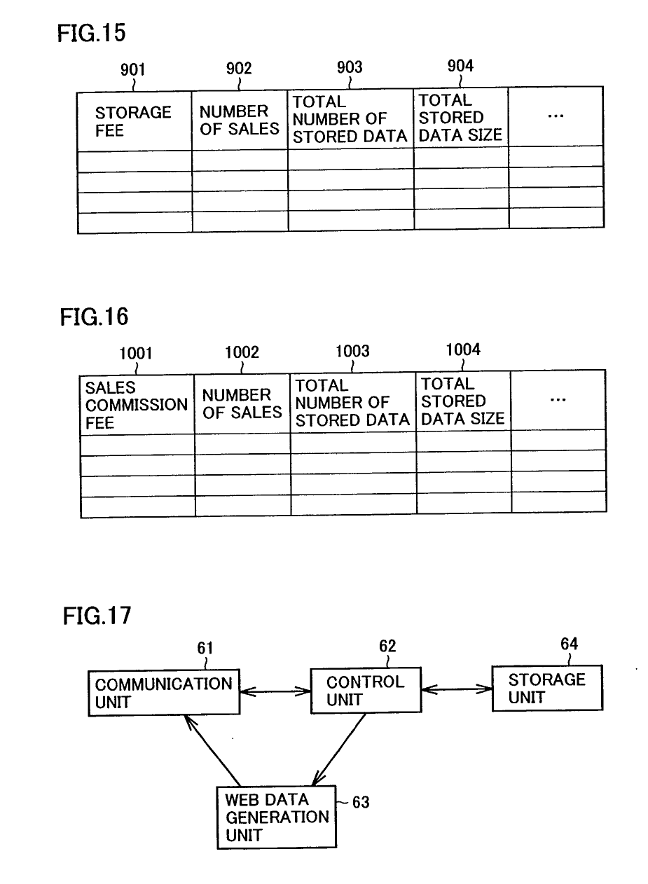

FIG. 15 shows a structure of the storage fee accounting determination table to determine storage fee 806 in the accounting table.

Referring to FIG. 15, the storage fee accounting determination table includes a storage fee 901, the number of sales 902, a total number of stored data 903, and total stored data size 904. Storage fee 901 is associated with storage fee 804 in the accounting table, and determined depending upon the number of sales 902, total number of stored data 903, and total stored data size 904. Number of sales 902 indicates the number of sales of mask design data 300. Total number of stored data 903 indicates the total number of mask design data accumulated for design maker A that has entrusted administration of mask design data 300. Total stored data size 904 indicates the total data size of mask design data accumulated for design maker A that has entrusted administration of mask design data 300.

To promote receipt of administration entrustments, storage fee 901 is set so as to become relatively lower in proportion to the total number of stored data 903 and total stored data size 904.

FIG. 16 shows a data structure of a sales commission fee accounting determination table to determine sales commission fee 805 in the accounting table.

Referring to FIG. 16, the sales commission fee accounting table includes a sales commission fee 1001, the number of sales 1002, the total number of stored data 103 and total stored data size 1004. Sales commission fee 1001 is associated with sales transmission fee 805 in the accounting table, and is determined depending upon the number of sales 1002, total number of stored data 1003 and total stored data size 1004. The number of sales 1002 indicates the number of sales of mask design data 300. Total number of stored data 1003 indicates the total number of mask design data accumulated for design maker A that has entrusted administration of mask design data 300. Total stored data size 1004 indicates the total size of the mask design data accumulated for design maker A that has requested administration of mask design data 300.

Similarly to storage fee 901, sales commission fee 1001 is set to become relatively lower in proportion to the number of sales 1002 to promote the receipt of administration entrustments.

Referring to FIG. 13 again, CPU 42 reads out from storage device 45 the various data of the storage fee accounting determination table and the sales commission fee accounting determination table when mask design data 300 is sold, or at a predetermined period to update storage fee 901 and sales commission fee 1001. CPU 42 also reads out various data from the accounting table from storage device 45 to update storage fee 804 and sales commission fee 805 based on storage fee 901 and sales commission fee 1001. When mask design data 300 is sold, the number of sales 806 is also updated. Then, CPU 42 outputs each updated data to storage device 45. Storage device 45 has the appropriate data stored in respective predetermined areas in the storage fee accounting determination table, sales commission fee accounting determination table and accounting table.

Access from each maker terminal utilizing mask design data sales system 100 to sales administration server 4 is effected through a web page.

FIG. 17 is a functional block diagram of sales administration server 4 indicating the function of data transfer with respective maker terminals. Referring to FIG. 17, sales administration server 4 includes a communication unit 61, a control unit 62, a web data generation unit 63 and a storage unit 64.

Communication unit 61 transfers data to/from each maker terminal via network 5.

Control unit 62 reads out from storage unit 64 the data to be transmitted to the accessing maker terminal, and also the web data to display in a web page the data at the display unit of the maker terminal according to an access from a maker terminal. The read out data is provided to web data generation unit 63 or communication unit 61.

Web data generation unit 63 adds the data to be transmitted to the maker terminal to the web data, and provides the data to communication unit 61.

Storage unit 64 stores each data received from the maker terminal, and each web data to display data at the display unit of a maker terminal according to the access from a maker terminal.

Disclosure of specification information will be described hereinafter as an example. Upon receipt of a specification information disclose request from wafer maker terminal 31 at communication unit 61, control unit 62 obtains from storage unit 64 web data to specify the request specification at the display unit of wafer maker terminal 31. Control unit 62 provides the obtained web data to communication unit 61. Communication unit 61 transmits the web data to wafer maker terminal 31 via network 5.

Upon receipt of data of which specification is requested by wafer maker terminal 31 at communication unit 61, control unit 62 retrieves from storage unit 64 disclosure entrustment specification data 500 including the specification information matching the requested specification. Control unit 62 determines whether wafer maker A that is the transmission source of the disclose request satisfies the disclosure condition such as not being included in the list of disclosure inhibited maker 512. When determination is made that wafer maker A satisfies the disclosure condition, control unit 62 provides the specification data according to disclosure level 510 to web data generation unit 63. Control unit 62 also obtains the web data to display the web page at the display unit of wafer maker terminal 31 from storage unit 64, and provides the obtained web data to web data generation unit 63. Web data generation unit 63 incorporates the specification data into the web data, and provides the same to communication unit 61. Communication unit 61 transmits the web data to wafer maker terminal 31 via network 5.

Thus, a list of specification data of mask design data matching the specification requested from wafer maker terminal 31 is displayed at the display unit of wafer maker terminal 31.

When the wafer maker wishes to purchase mask design data 300, the area of specification data related to mask design data 300 displayed at the display unit of wafer maker terminal 31 is clicked with a mouse. This causes a purchase request of mask design data 300 to be transmitted from wafer maker terminal 31 to sales administration server 4. Upon receipt of a purchase request of mask design data 400 from wafer maker terminal 31 at communication unit 61, control unit 62 obtains from storage unit 64 the web data required to display the input form of purchase request specification data 700. The obtained web data is provided to web data generation unit 63. Control unit 62 also provides to web data generation unit 63 other data to specify mask design data 300 such as the product number of mask design data 300, the photomask name and the like. Web data generation unit 63 adds the data such as the product number of mask design data 300 and the photomask name into the input form of purchase request specification data 700. The web data is transmitted to communication unit 61. Communication unit 61 transmits the web data to wafer maker terminal 31 via network 5.

Then, wafer maker A enters predetermined data into the input form of purchase request specification data 700 displayed at the display unit of wafer maker terminal 31. The entered purchase request specification data 700 is transmitted from wafer terminal 31 to sales administration server 4 via network 5.

Thus, sales administration server 4 discloses specification information to wafer maker A, and wafer maker A that has sent a disclose request requests the purchase of desired mask design data based on the specification data disclosed on the web.

Design maker terminals 11 and 12, mask maker terminals 21 and 22, and wafer maker terminals 31 and 32 include a general browser software that allows a web page to be displayed as well as a display unit, and is the well-known computer such as a personal computer that can be connected to network 5. Particular description thereof is not provided here.

The series of process flow from the storage and administration entrustment of mask design data 300 to the sales of mask design data 300 according to the first embodiment of the present invention will be described hereinafter.

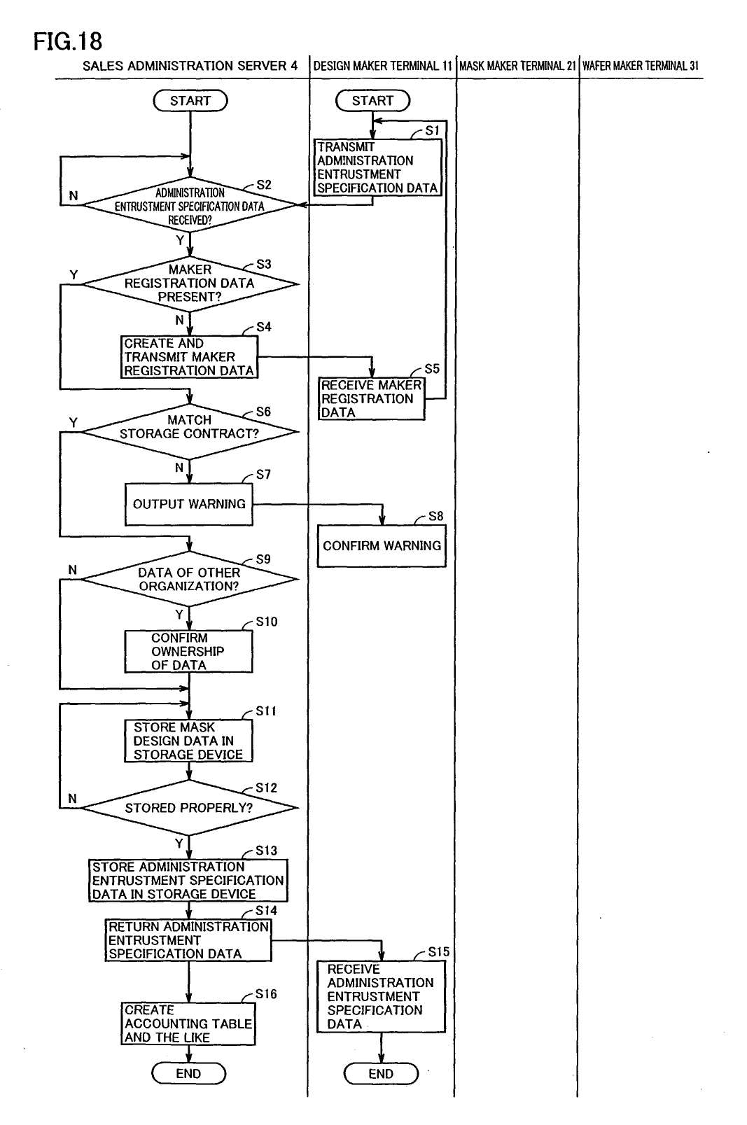

FIG. 18 is a flow chart of the process of design maker A entrusting storage of mask design data 300 to sales administration server 4 from design maker terminal 11.

Referring to FIG. 18, design maker terminal 11 attaches mask design data 300 to administration entrustment specification data 400, and transmits the data to sales administration server 4 via network 5 (step S1). Upon receipt of administration entrustment specification data 400 (step S2), sales administration server 4 obtains administration entruster code 403 in administration entrustment specification data 400, and determines whether there is mask registration data 200 corresponding to design maker A (step S3).

When determination is made that corresponding mask registration data 200 is not present, sales administration server 4 generates maker registration data 200 corresponding to design maker A, and transmits the created maker registration data 200 to design maker terminal 11 via network 5 (step S4). Upon receipt of maker registration data 200 (step S5), control returns to step S1 where design maker terminal 11 transmits again administration entrustment specification data 400.

When determination is made that maker registration data 200 corresponding to design maker A is present at step S3, sales administration server 4 determines whether the contents of administration entrustment specification data 400 matches the contents of the storage contract entered in advance with design maker A (step S6).

When determination is made that the contents of administration entrustment specification data 400 does not match the contents of the storage contract, sales administration server 4 sends to design maker terminal 11 via network 5 a message that the administration request is unaccepted and a warning that the received mask design data 300 will be erased unless a response to the unacceptance is obtained within a predetermined period of time (step S7). Design maker A confirms the warning data at design maker terminal 11 (step S8). Design maker A checks the presence/absence of a storage contract and whether there is no input error in administration entrustment specification data 400.

When there is no response to the unacceptance of the administration entrustment from design maker A within a predetermined period of time, sales administration server 4 erases the received mask design data 300 and sends a notification to design maker terminal 11 that mask design data 300 has been erased via network 5.

When determination is made that the contents of administration entrustment specification data 400 matches the contents of the storage contract at step S6, sales administration server 4 compares administration entruster code 403 in the received administration entrustment specification data 400 with design maker code 402 to check whether mask design data 300 that is the subject of administration entrustment is mask design data designed by an organization other than design maker A (step S9).

When administration entruster code 403 matches design maker code 402, and determination is made that mask design data 300 which is the subject of administration entrustment is the mask design data designed by design maker A, control proceeds to step S11.

When administration entruster code 403 does not match design maker code 402 and determination is made that mask design data 300 which is the subject of administration entrustment is mask design data designed by an organization other than the maker who has entrusted administration of mask design data 300 at step S9, sales administration server 4 confirms the ownership of mask design data 300 through a storage contract entered in advance (step S10). Then, control proceeds to step S11.

Sales administration server 4 stores the received mask design data 300 in storage device 45 (step S11). Mask design data is critical in determining a circuit configuration of a semiconductor device. Any deficiency in mask design data will adversely affect the fabrication line of the mask maker fabricating photomasks from the mask design data as well as on the fabrication line of the wafer maker that fabricates semiconductor devices using the produced photomask. Therefore, sales administration server 4 monitors the storage of mask design data 300 until the recording operation ends properly (step S12).

When sales administration server 4 determines that the storing operation of mask design data 300 has ended properly (step S12), administration entrustment specification data 400 is stored in the administration entrustment specification table of storage device 45 (step S13). Sales administration server 4 transmits to design maker terminal 11 via network 5 administration entrustment specification data 400 (mask design data 300 not added) as a receipt notification with respect to the storage and administration entrustment of mask design data 300 (step S14). Design maker terminal 11 receives administration entrustment specification data 400 to confirm that the storage process of mask design data 300 which is the subject of administration entrustment has been effected (step S15).

When the storage process of mask design data 300 is completed, sales administration server 4 generates an accounting table for mask design data 300 which is the subject of administration entrustment, a storage fee accounting determination table and a sales commission fee accounting determination table to initiate the accounting on the administration of the mask design data 300 (step S16).

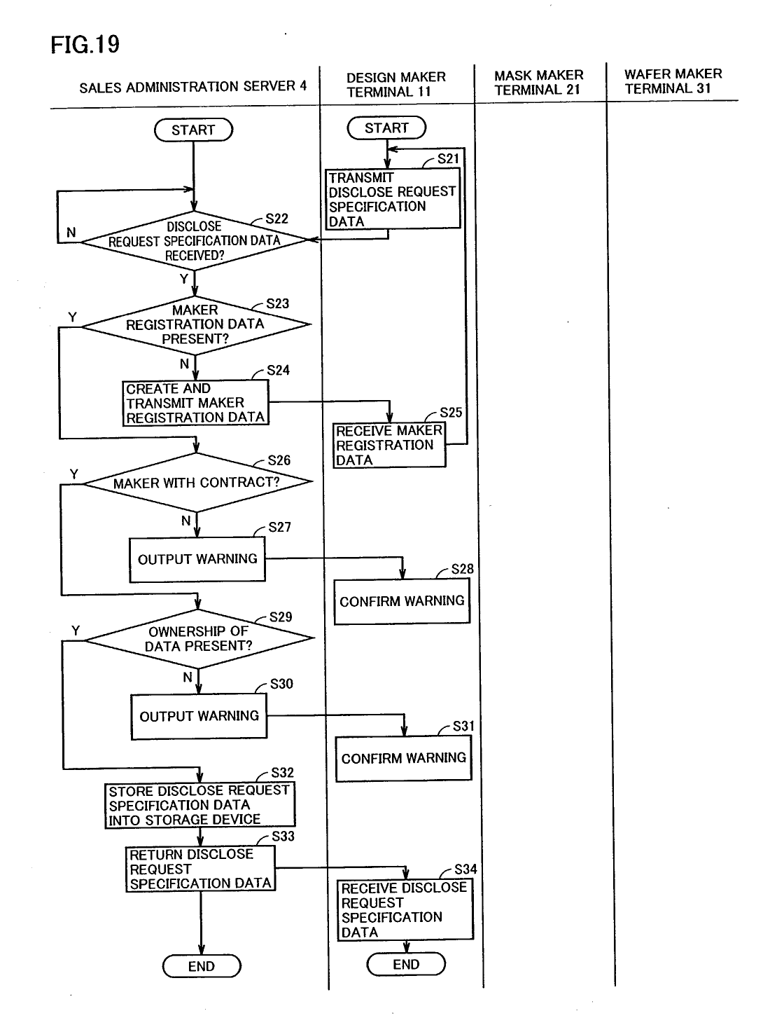

FIG. 19 is a flow chart of the process of design maker A entrusting disclosure of the specification information related to mask design data 300 which is the subject of administration entrustment to sales administration server 4 from design maker terminal 11.

Referring to FIG. 19, design maker terminal 11 transmits to sales administration server 4 via network 5 disclosure entrustment specification data 500 corresponding to mask design data 300 under administration entrustment (step S21). Upon receipt of disclosure entrustment specification data 500 (step S22), sales administration server 4 obtains disclose entruster code 504 in disclosure entrustment specification data 500 to check whether maker registration data 200 corresponding to design maker A is present or not (step S23).

When determination is made that maker registration data corresponding to design maker A is not registered, sales administration server 4 creates maker registration data 200 for design maker A and transmits the generated maker registration data 200 to design maker terminal 11 via network 5 (step S24). Upon receipt of maker registration data 200 (step S25), control returns to step S21 where design maker terminal 11 transmits disclosure entrustment specification data 500 again.

When determination is made that maker registration data 200 for design maker A is present at step S23, sales administration server 4 determines the absence of a contract with design maker A (step S26).

When determination is made that design maker A is not a maker that has entered a contract, sales administration server 4 sends warning data indicating that the disclosure entrustment is unaccepted to design maker terminal 11 via network 5 (step S27). Design maker A confirms the warning data at design maker terminal 11 (step S28). Design maker A confirms the presence of a contract as well as whether there is any input error in disclosure entrustment specification data 500.

When determination is made that design maker A is a maker that has entered into a contract at step S26, sales administration server 4 checks whether design maker A has the ownership of mask design data 300 through a contract entered previously (step S29).

When determination is made that design maker A does not posses the ownership of mask design data 300, sales administration server 4 transmits warning data indicating that the disclosure entrustment is unaccepted to design maker terminal 11 via network 5 (step S30). Design maker A confirms the warning data at design maker terminal 11 (S31), and checks the absence/presence of the ownership of mask design data 300 as well as whether there is any input error in disclosure entrustment specification data 500.

When determination is made that design maker A has the ownership of mask design data 300 at step S29, sales administration server 4 assigns a disclosure number 515 to the received disclosure entrustment specification data 500. Disclosure entrustment specification data 500 is stored in the disclosure entrustment specification table of storage device 45 (step S32). Sales administration server 4 obtains disclosure entrustment specification data 500 from storage device 45 as a receipt notification with respect to the disclosure entrustment, and transmits the obtained disclosure entrustment specification data 500 to design maker terminal 11 via network (step S33). Design maker terminal 11 receives disclosure entrustment specification data 500 to confirm that the disclosure entrustment registration process has been carried out (step S34).

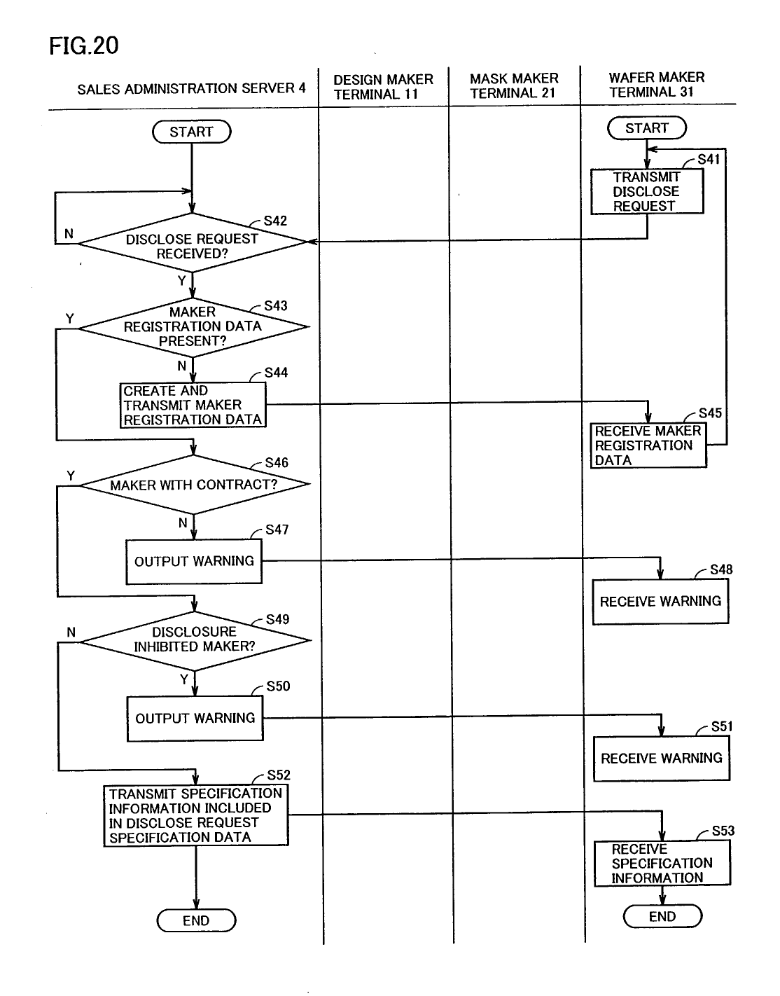

FIG. 20 is a flow chart of the process of disclosing the specification information related to mask design data 300 to wafer maker A that wishes to purchase mask design data 300.

Referring to FIG. 20, wafer maker terminal 31 transmits a specification information disclose request related to mask design data 300 that is the subject of administration entrustment to sales administration server 4 via network 5 (step S41). Upon receipt of a specification information disclose request (step S42), sales administration server 4 confirms the code of wafer maker A that has requested the disclosure of specification information, and checks whether maker registration data 200 corresponding to that maker code is present or not (step S43).

When determination is made that maker registration data 200 corresponding to wafer maker A is not present, sales administration server 4 generates maker registration data 200 corresponding to wafer maker A, and transmits the created maker registration data 200 to wafer maker terminal 31 via network 5 (step S44). Upon receipt of maker registration data 200 (step S45), control returns to step S41 where wafer maker terminal 31 transmits again a specification information disclose request.

When determination is made that maker registration data 200 corresponding to wafer maker A is present at step S43, sales administration server 4 checks whether a contract has been entered with wafer maker A (step S46).

When determination is made that wafer maker A is not a maker that has entered into a contract, sales administration server 4 transmits warning data indicating that the disclose request is unaccepted to wafer maker terminal 31 via network 5 (step S47). Wafer maker A confirms the warning data at wafer maker terminal 31 (step S48), and checks whether a contract has been entered or not.

When determination is made that wafer maker A is a maker with a contract at step S46, sales administration server 4 reads out disclosure entrustment specification data 500 corresponding to mask design data 300 that is the subject of the disclose request from storage device 45 to compare the maker code of wafer maker A with the maker code included in disclosure inhibited maker 512. Determination is made whether wafer maker A is included in the list of disclosure inhibited maker 512 (step S49).

When determination is made that wafer maker A is included as a disclosure inhibited maker, sales administration server 4 transmits warning data indicating that disclosure is not allowed to wafer maker terminal 31 via network 5 (step S50). Wafer maker A receives and confirms the warning data at wafer maker terminal 31 (step S51).

When determination is made that wafer maker A is not included in the list of disclosure inhibited maker at step S49, sales administration server 4 transmits to wafer maker terminal 31 via network 5 the specification data of photomask name 505, photomask factor 506, device type 507, design rule 508 and semiconductor device factor 509 based on disclosure level 510 included in disclosure entrustment specification data 500 read out from storage device 45 (step S52). Wafer maker A receives the specification information at wafer maker terminal 31 (step S53). Upon confirming the contents thereof, the desired mask design data 300 is purchased.

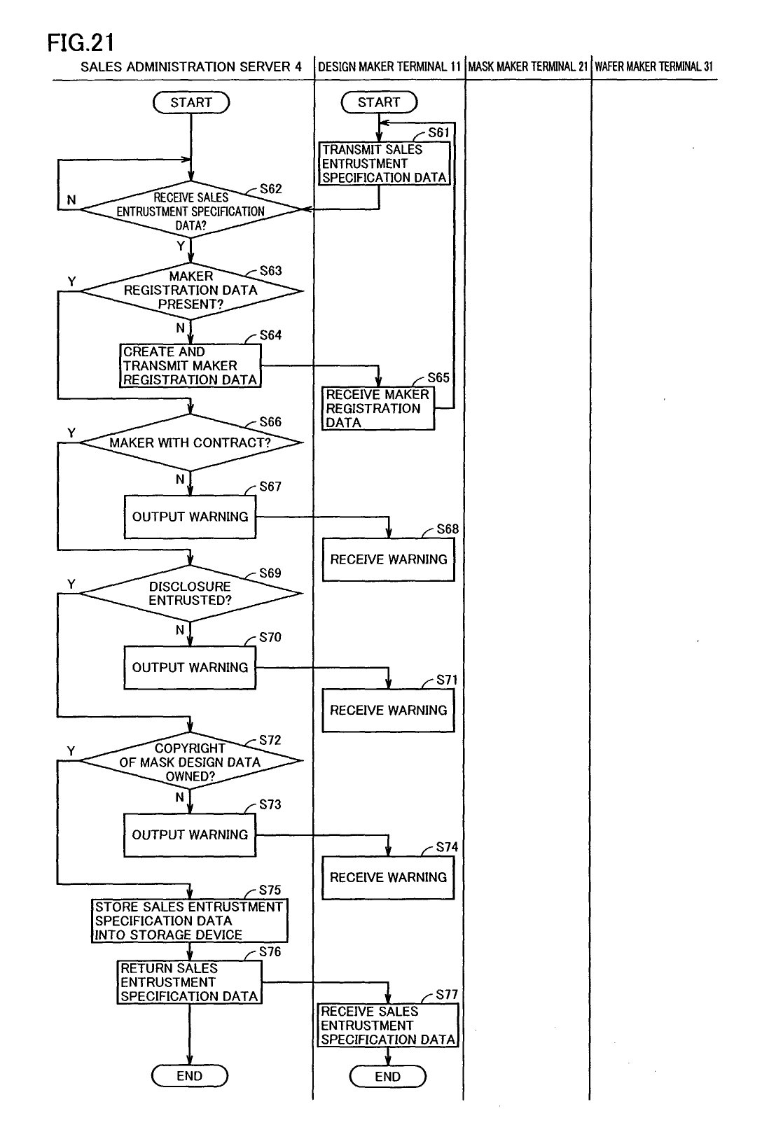

FIG. 21 is a flow chart of the process of design maker A entrusting sales of mask design data 300 with respect to sales administration server 4 from design maker terminal 11.

Referring to FIG. 21, design maker terminal 11 transmits sales entrustment specification data 600 corresponding to mask design data 300 under administration entrustment to sales administration server 4 via network 5 (step S61). Upon receipt of sales entrustment specification data 600 (step S62), sales administration server 4 obtains sales entruster code 602 in sales entrustment specification data 600 to check whether maker registration data 200 corresponding to design maker A is present or not (step S63).

When determination is made that maker registration data 200 corresponding to design maker A is not present, sales administration server 4 generates maker registration data 200 corresponding to design maker A, and transmits the created maker registration data 200 to design maker terminal 11 via network 5 (step S64). Upon receipt of maker registration data 200, control returns to step S61 where design maker terminal 11 retransmits sales entrustment specification data 600.

When determination is made that there is maker registration data 200 corresponding to design maker A at step S63, sales administration server 4 checks the presence of a contract with design maker A (step S66).

When determination is made that the maker of the sales entrustment is not a maker with a contract, sales administration server 4 transmits warning data indicating that the sales entrustment is unaccepted to design maker terminal 11 via network 5 (step S67). Design maker A confirms the warning data at design maker terminal 11 (step S68), and checks the presence/absence of a contract and whether there is any input error in sales entrustment specification data 600.

When determination is made that design maker A is a maker that has entered into a contract, sales administration server 4 obtains a disclosure number 603 from sales entrustment specification data 600, and checks whether disclosure entrustment specification data 500 corresponding to the disclosure number stored in disclosure number 603 is present in the disclosure entrustment specification table. In other words, sales administration server 4 determines whether disclosure entrusted with respect to mask design data 300 that is the subject of sales entrustment (step S69).

When determination is made that disclosure is not entrusted, sales administration server 4 transmits to design maker terminal 11 via network 5 warning data indicating that the sales entrustment is not accepted since disclosure is not entrusted with respect to mask design data 300 that is the subject of sales entrustment (step S70). Design maker A confirms the warning data at design maker terminal 11 (step S71), and checks the disclosure entrustment as to the unaccepted mask design data 300 as well as entrusting again sales of mask design data 300.

When determination is made that disclosure is entrusted for mask design data 300 that is the subject of sales entrustment at step S69, sales administration server 4 checks whether design maker A has the copyright on mask design data 300 through a pre-entered contract (step S72).

When determination is made that design maker A does not possess the copyright of mask design data 300, sales administration server 4 transmits to design maker terminal 11 via a network 5 warning data indicating that sales entrustment is not accepted since sales of mask design data 300 is entrusted from a maker that does not have the copyright (step S73). Design maker A confirms the warning data at design maker terminal 11 (step S74).

When determination is made that design maker A has the copyright of mask design data 300 at step S72, sales administration server 4 stores the received sales entrustment specification data 600 into the sales entrustment specification table of storage device 45 (step S75). Sales administration server 4 transmits to design maker terminal 11 via network 5 sales entrustment specification data 600 as a receipt notification with respect to the sales entrustment of mask design data 300 (step S76). Design maker terminal 11 receives sales entrustment specification data 600 to confirm the registration process of sales entrustment (step S77).

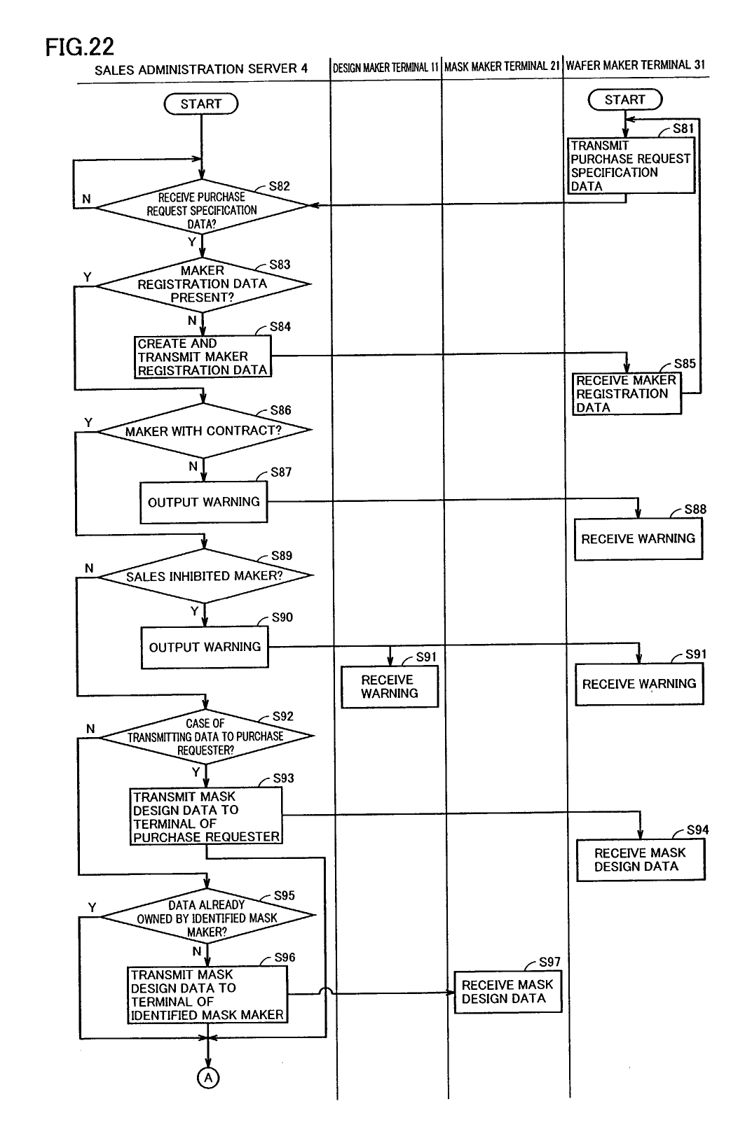

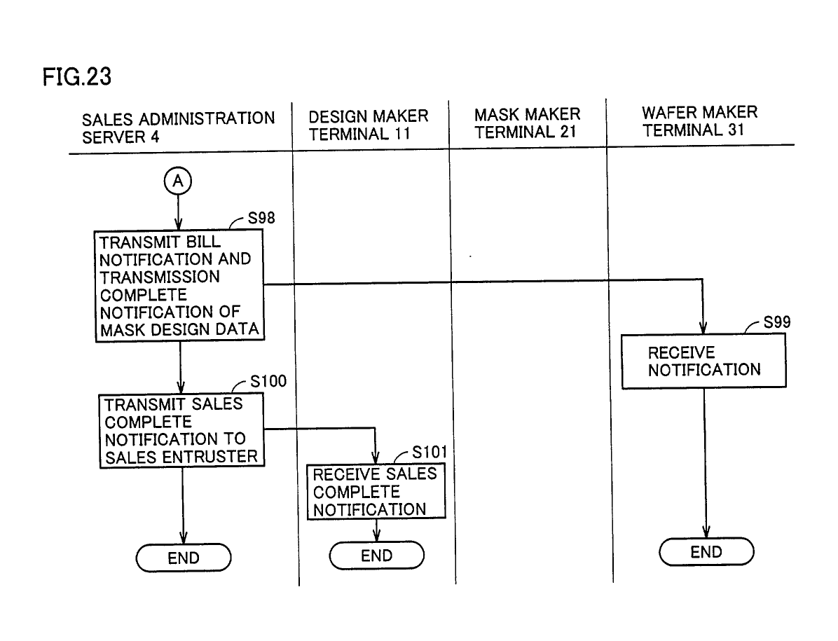

FIGS. 22 and 23 are flow charts of the process for sales administration server 4 selling mask design data 300 to a maker that is the user of wafer maker terminal 31.

Referring to FIG. 22, wafer maker terminal 31 transmits purchase request specification data 700 of mask design data 300 that is to be purchased to sales administration server 4 via network 5 (step S81). Upon receipt of purchase request specification data 700 (step S82), sales administration server 4 confirms the maker code of purchase requester code 705 included in purchase request specification data 700 to check whether there is maker registration data 200 corresponding to wafer maker A (step S83).

When determination is made that maker registration data 200 for wafer maker A is not present, sales administration server 4 generates maker registration data 200 corresponding to wafer maker A, and transmits the created maker registration data 200 to wafer maker terminal 31 via network 5 (step S84). Upon receiving maker registration data 200 (step S85), control returns to step S81 where wafer maker terminal 31 transmits again purchase request specification data 700.

When determination is made that there is maker registration data 200 corresponding to wafer maker A at step S83, sales administration server 4 checks whether a contract is entered with wafer maker A (step S86).

When determination is made that wafer maker A is a maker without a contract, sales administration server 4 transmits to wafer maker terminal 31 via a network 5 warning data indicating that the purchase request is unaccepted (step S87). Wafer maker A confirms the warning data at wafer maker terminal 31 (step S81), and checks the presence of a contract and whether there is any input error in purchase request specification data 700.

When determination is made that wafer maker A is a maker with a contract at step S86, sales administration server 4 reads out from storage device 45 sales request specification data 600 corresponding to mask design data 300 which is requested to be purchased. The maker code of wafer maker A is compared with the maker code included in sales inhibited maker 607 to check whether wafer maker A corresponds to a sales inhibited maker (step S89).

When determination is made that wafer maker A is a sales inhibited maker, sales administration server 4 transmits warning data indicating that sales is not allowed to wafer maker terminal 31 and design maker terminal 11 that is the source of administration entrustment of mask design data 300 via network 5 (step S90). Wafer maker A and design maker A confirm the warning data at wafer maker terminal 31 and design maker terminal 11, respectively (step S91).

When determination is made that wafer maker A is not included in the list of sales inhibited maker at step S89, sales administration server 4 compares the maker code of transmission destination 709 in the received purchase request specification data 700 with the maker code of purchase requester code 705 to check whether mask design data 300 is to be transmitted to wafer maker terminal 31 that is the source of the purchase request (step S92).

When the maker code of transmission destination 709 matches the maker code of purchase requester code 705 so that determination is made that mask design data 300 can be transmitted to wafer maker terminal 31, sales administration server 4 transmits mask design data 300 to wafer maker terminal 31 via network (step S93). Then, control proceeds to step S98 of FIG. 23. Wafer maker terminal 31 receives the purchased mask design data 300 (step S94).

When the maker code of transmission destination 709 does not match a maker code of purchase requester code 705 so that determination is made that mask design data 300 is not to be transmitted to wafer maker terminal 31 at step S92, sales administration server 4 determines that mask design data 300 is to be transmitted to mask maker A that is the identified mask maker specified in transmission destination 709. Sales administration server 4 compares the maker code of transmission destination 709 with the maker code of administration entruster code 403 in administration entrustment specification data 400 corresponding to mask design data 300 that is requested to be purchased to confirm whether the administration entrustment of mask design data 300 has been issued from an identified mask maker designated at transmission destination 709. In other words, sales administration server 4 confirms whether mask maker A designated in transmission destination 709 already possesses mask design data 300 requested to be purchased (step S95).

When determination is made that mask maker A that is an identified mask maker possesses mask design data 300 already, sales administration server 4 does not have to transmit mask design data 300 to mask maker terminal 21 designated at transmission destination 709. Therefore, control proceeds to step S98 of FIG. 23.

When determination is made that mask maker A that is the identified mask maker does not possess mask design data 300 at step S95, sales administration server 4 transmits mask design data 300 to mask maker terminal 21 via network 5 (step S96). Mask maker terminal 21 receives mask design data 300 purchased by wafer maker A from sales administration server 4 (step S97).

Referring to FIG. 23, following the completion of the transmission of mask design data 300, sales administration server 4 transmits a transmission complete notification of mask design data 300 and a bill notification of the sales commission fee to wafer maker terminal 31 via network 5 (step S98). Wafer maker A receives each specification at wafer maker terminal 31 (step S99). Sales administration server 4 also transmits a sales complete notification notifying the sales of mask design data 300 to design maker terminal 11 that is the sales entruster via network 5 (step S100). Design maker A receives the sales complete notification at design maker terminal 11 (step S 101).

Thus, the sales of mask design data from design maker A to wafer maker A is conducted.

The above description of the processing flow is based on the transmission and receipt of mask design data 300 through network 5. However, the process can be carried out through a transmission medium 406 included in administration entrustment specification data 400, or a requested transmission medium 708 included in purchase request specification data 700 by specifying the recording medium.

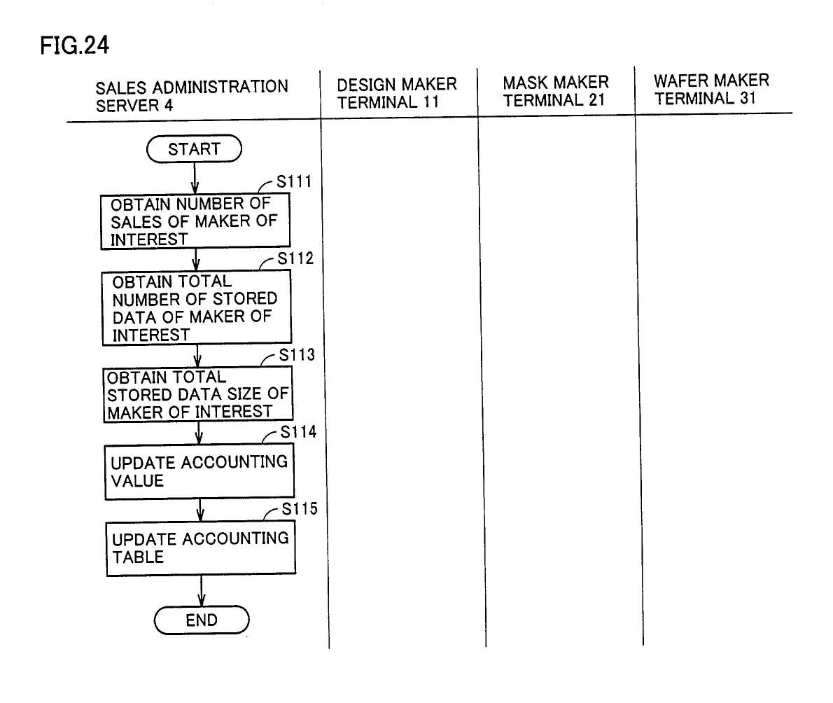

FIG. 24 is a flow chart of the accounting process for design maker A entrusting administration of mask design data 300.

Referring to FIG. 24 sales administration server 4 reads out the number of sales 902 and 1002 corresponding to mask design data 300 under administration entrustment by design maker A from the storage fee account determination table and the sales commission fee account determination table in storage device 45 so as to check the accounting with respect to design maker A when mask design data 300 is sold or at every predetermined period of time (step S 111).

Sales administration server 4 also reads out the total number of stored data 903 and 1003 of the mask design data under administration entrustment by design maker A from the storage fee account determination table and sales commission fee account determination table of storage device 45 (step S112).

Sales administration server 4 also reads out the total number of stored data sizes 904 and 1004 of the mask design data under administration entrustment by design maker A from the storage fee account determination table and sales commission fee account determination table of storage device 45 (step S113).

Sales administration server 4 also updates storage fee 901 for mask design data 300 based on the number of sales 902, total number of stored data 903 and total stored data size 904. Sales administration server 4 also updates sales commission fee 1001 for mask design data 300 based on the number of sales 1002, total number of stored data 1003 and total stored data size 1004 (step S114).

Sales administration server 4 obtains the storage fee 804 and sales commission fee 805 in the accounting table from storage device 45 to update storage fee 804 with storage fee 901 and sales commission fee 805 with sales commission fee 1001 (step S115). Sales administration server 4 writes the updated data into storage device 45.

The above description is based on the case where administration entrustment of mask design data 300 is issued from design maker terminal 11 to sales administration server 4, a purchase request of mask design data 300 is issued from wafer maker terminal 31 to sales administration server 4, and mask design data 300 is purchased according to the designation from wafer maker terminal 31 to mask maker terminal 21.

It is to be noted that the maker entrusting storage of mask design data 300 is not limited to design maker A. For example, the maker entrusting storage of mask design data 300 may be another design maker B that has obtained the ownership of mask design data from design maker A, or other mask makers A or B, or wafer makers A and B. In this case, the maker entrusting administration of mask design data 300 sets its own maker code in administration entruster code 403 in administration entrustment specification data 400, and sets the code of design maker A in design maker code 402.

The maker requesting purchase of mask design data 300 is not limited to wafer maker A, and may be another wafer maker B or mask makers A or B, or even a design maker B.

Furthermore, the maker entrusting disclosure of specification information related to mask design data 300 may differ from the maker entrusting administration of mask design data 300. For example, in the case where mask maker A or mask maker B entering into a production contract with design maker A entrusts administration of mask design data 300 obtained from design maker A under the approval of design maker A, design maker A having the ownership of mask design data 300 may entrust disclosure.

Also, the maker entrusting sales of mask design data 300 may differ from the maker that entrusts administration of mask design data 300. For example, in the case where mask makers A and B entering into a production contract with design maker A entrust administration of mask design data 300 obtained from design maker A under approval of design maker A, design maker A that has the ownership of mask design data 300 can entrust sales of mask design data 300.

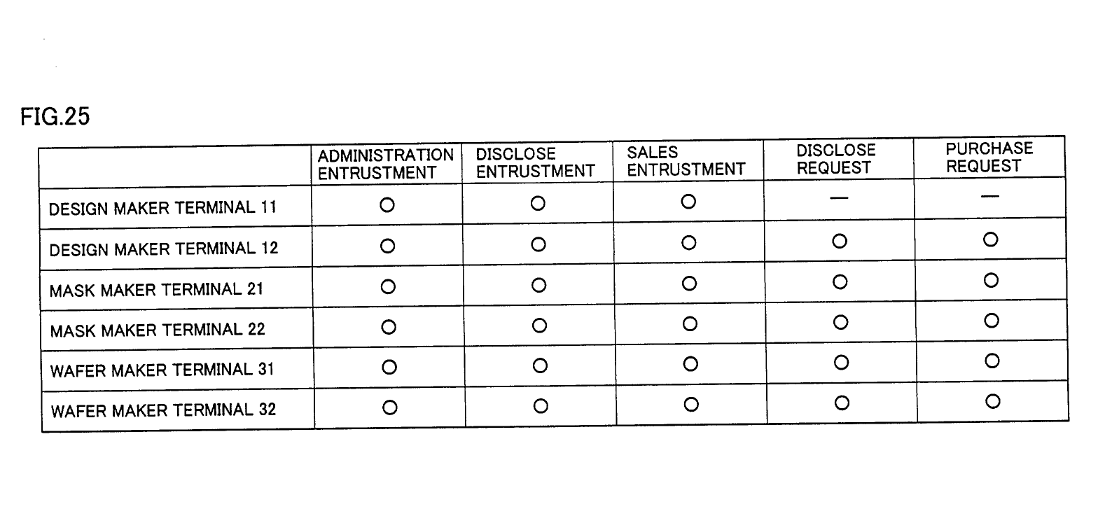

FIG. 25 is a list indicating whether respective terminals can effect an administration entrustment, a disclosure entrustment, a sales entrustment, a disclose request and a purchase request for mask design data 300 designed by design maker A. In FIG. 25, “◯” indicates that the relevant entrustment or request is allowed. It is to be noted that the terminal that issues respective entrustments and requests must satisfy the conditions required for respective entrustments and requests. The “−” sign in FIG. 25 indicates that such a case is not possible.

According to the above-described first embodiment, the sales of mask design data is mediated based on administration entrustment specification data 400, disclosure entrustment specification data 500 and sales entrustment specification data 600 received from the terminal of a maker entrusting administration, disclosure and sales of mask design data, and purchase request specification data 700 received from a terminal of a maker wishing to purchase mask design data. The tedious procedure for purchase and sales is no longer required for each maker. The cost and time required for the purchase and sales can be suppressed.

Also, since mask design data generally of large size is stored on the part of sales administration server 4, the maker possessing the mask design data can reduce the cost for administration of the mask design data.

Disclosure of specification information related to mask design data can be limited as desired by the maker that entrusts disclosure of specification information related to mask design data. Also, the party to which mask design data is sold can be restricted as desired by the maker entrusting sales of mask design data. Therefore each maker can prevent outflow of the know-how related to mask design data to a competent organization.

Reduction in the sales commission fee and administration fee according to the number of sales and the size of the stored mask design data of interest promotes makers to entrust more mask design data for administration. The maker entrusting administration of mask design data can lower the cost required for administration of mask design data. Also, the administrator carrying out administration of mask design data can collect more administration fee and sales commission fee.

Second Embodiment

The mask design data sales system of a photomask according to a second embodiment of the present invention has a structure similar to that of mask design data sale system 100 of the first embodiment.

Similarly in the second embodiment, design maker A that is the user of design maker terminal 11 entrusts administration and sales of mask design data to sales administration server 4. Design maker A creates administration entrustment specification data, disclosure entrustment specification data and sales entrustment specification data to entrust administration and sales of mask design data to sales administration server 4. The operation of design maker terminal 11 transmitting each data created by design maker A to sales administration server 4 is similar to that described in the first embodiment.

In the second embodiment, design maker terminal 11 does not transmit the mask design data to sales administration server 4 via network 5. The mask design data is stored in design maker terminal 11. In the administration entrustment specification data, the maker code of design maker A is set as the storage source maker of mask design data.

Wafer maker A that is the user of wafer maker terminal 31 sends a mask design data purchase request to sales administration server 4. Wafer maker A creates the specification information disclose request data and purchase request specification data related to mask design data that is the subject of purchase to sales administration server 4. The operation of wafer maker terminal 31 transmitting the specification information disclose request and purchase request specification data to sales administration server 4 is similar to that described in the previous first embodiment.

In the second embodiment, the mask design data purchased by wafer maker terminal 31 is not transmitted from sales administration server 4. The mask design data is transmitted from design maker terminal 11 storing the mask design data to mask maker terminal 21 of mask maker A that fabricates photomasks via network 5.

Sales administration server 4 functions to supervise the storage source information of mask design data and mediate the purchase and sales of mask design data between design maker A that entrusts sales of mask design data and a wafer maker A that wishes to purchase that mask design data. The operation of sales administration server 4 as to the assignment and administration of a maker code and password to makers utilizing mask design sales system 100 is similar to that described in the previous first embodiment.

Also, the operation of sales administration server 4 in response to a mask design data administration entrustment, disclosure entrustment and sales entrustment issued from design maker terminal 11 is similar to that described in the previous first embodiment. It is to be noted that, when administration entrustment is issued from design maker terminal 11 in the second embodiment, sales administration server 4 receives only the administration entrustment specification data including the storage source information of the mask design data, and does not actually receive the mask design data from design maker terminal 11.

The operation of sales administration server 4 carried out in response to a specification information disclose request on the mask design data issued from mask maker terminal 31 is similar to that described in the previous first embodiment.

Also, the operation of sales administration server 4 as to the receipt and administration of purchase request specification data from wafer terminal 31 as well as to the determination of whether sales of mask design data to wafer maker A is allowed or not is similar to that described in the previous first embodiment.

In the second embodiment, when sales administration server 4 determines that sales of mask design data to wafer maker A is allowed, notification of a mask design data purchase application is transmitted to the mask design data storage source maker indicated in the administration entrustment specification data. Also, a notification is transmitted instructing the transmission of the mask design data to the terminal of the transmission destination maker specified in the purchase request specification data.

The process of sales administration server 4 as to determining the sales commission fee of mask design data for design maker A is similar to that described in the previous first embodiment. It is to be noted that the process related to determining the storage fee described in the first embodiment is not carried out in the second embodiment since the mask design data is not stored at sales administration server 4.

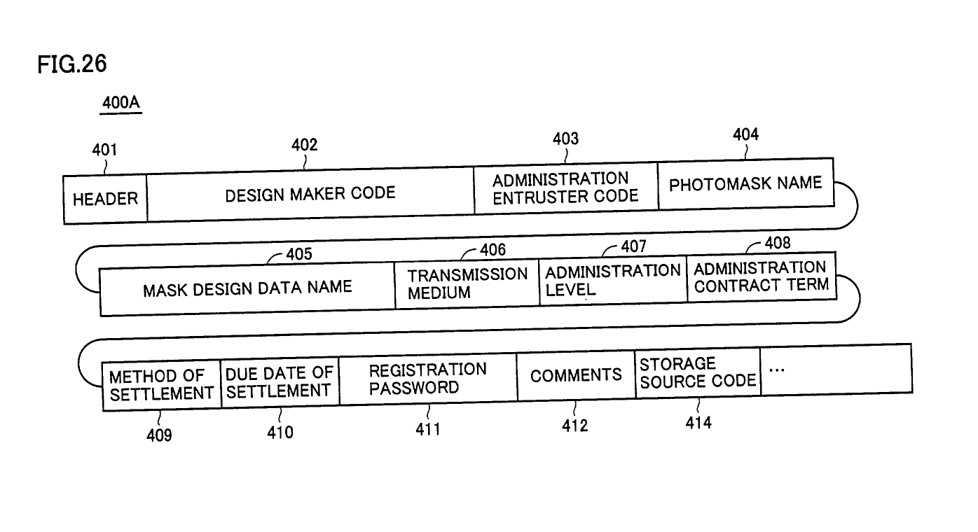

FIG. 26 shows the data structure of administration entrustment specification data 400A of the second embodiment. Administration entrustment specification data 400A also includes a storage source code 414 in addition to the various data included in administration entrustment specification data 400. Storage source code 414 is the code of the maker that is storing the mask design data. The maker code of design maker A is specified in storage source code 414. Since mask design data is not transmitted to sales administration server 4 in the second embodiment, design maker A does not have to specify the data of transmission medium 404 indicating the transmission medium of the mask design data and administration level 407 indicating the administration level of mask design data in administration entrustment specification data 400A.

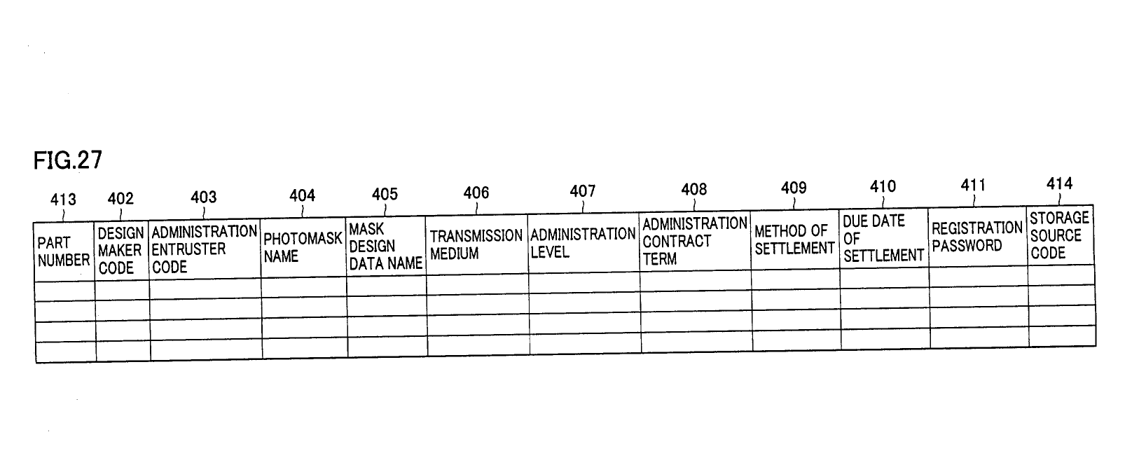

Upon receipt of administration entrustment specification data 400A, sales administration server 4 assigns a product number 413 and stores the same in the administration entrustment specification table shown in FIG. 27.

The remaining items of the maker registration data, mask design data, disclosure entrustment specification data, sales entrustment specification data and purchase request specification data are identical to maker registration data 200, mask design data 300, disclosure entrustment specification data 500, sales entrustment specification data 600 and purchase request specification data 700 described in the first embodiment.

Referring to FIG. 1 again, design maker terminal 11 transmits administration entrustment specification data 400A including the data of storage source 414 of mask design data 300 to sales administration server 4 via network 5 in the present second-embodiment. It is to be noted that mask design data 300 is not attached to administration entrustment specification data 400A. Mask design data 300 remains stored at design maker terminal 11.

The operation of mask design data sales system 100 as to the subsequent maker registration, disclosure entrustment, sales entrustment and specification information disclose request is similar to that described in the previous first embodiment.

The operation as to the purchase request of mask design data sale system 100 differs from that of the previous first embodiment. Specifically, upon receiving purchase request specification data 700 from wafer maker terminal 31 via network 5, sales administration server 4 stores the received purchase request specification data 700 in the purchase request specification table shown in FIG. 12. Sales administration server 4 obtains sales entrustments specification data 600 corresponding to mask design data 300 that is the subject of purchase from the sales entrustment specification table, and determines whether the sales of mask design data 300 of interest to wafer maker A is allowed or not based on the sales condition such as being a sales inhibited maker 607 and also sales term 612.

When determination is made that the sales of mask design data 300 is allowed, sales administration server 4 obtains administration entrustment specification data 400A corresponding to mask design data 300 that is the subject of purchase from the administration entrustment specification table to transmit a notification of a purchase application of mask design data 300 as well as purchase request specification data 700 to design maker terminal 11 of design maker A that is the storage source makers based on the maker code in storage source code 414.

Upon receiving a purchase apply notification and purchase request specification data 700, design maker terminal 11 transmits mask design data 300 to mask maker terminal 21 of mask maker A specified as transmission destination 709 through a specified medium at the specified date based on the data of requested transmission date 707 and requested transmission medium 708 in purchase request specification data 700.

The operation of sales administration server 4 will be described hereinafter. In the second embodiment, the operation in accordance with receipt of various data such as administration entrustment specification data 400A, disclosure entrustment specification data 500, sales entrustment specification data 600 and disclose request of specification information on mask design data 300 are similar to that described in the previous first embodiment. It is to be noted that the storage of mask design data 300 into storage device 45 is not carried out in the second embodiment since mask design data 300 is not received at sales administration server 4. The operation carried out when sales administration server 4 receives purchase request specification data 700 from wafer maker terminal 31 will be described hereinafter.

Referring to FIG. 13, upon receipt of purchase request specification data 700 from network 5 at input/output interface device 41, CPU 42 writes purchase request specification data 700 into RAM 43. CPU 42 reads out the maker code of purchase requester code 705 in purchase request specification data 700 from RAM 43 to check the presence of maker registration data 200 corresponding to wafer maker A that has issued the purchase request. CPU 42 creates maker registration data 200 corresponding to wafer maker A, when not yet registered, and instructs input/output interface device 41 to transmit the generated maker registration data 200 to wafer maker terminal 31 that is the transmission source of purchase request specification data 700. Then, input/output interface device 41 transmits maker registration data 200 to wafer maker terminal 31 via network 5.

CPU 42 searches for purchase request specification data 600 corresponding to mask design data 300 based on product number 703 in purchase request specification data 700 from storage device 45. That purchase request specification data 600 is read out and written into RAM 43. CPU 42 checks the sales condition such as whether the maker code of purchase requester code 705 is a purchase inhibited maker 607 or whether purchase term 612 is satisfied or not based on purchase request specification data 700 and sales entrustment specification data 600.

When determination is made that wafer maker A indicated as the transmission source of purchase request specification data 700 satisfies the sales condition, CPU 42 checks whether the maker code of transmission destination 709 is not a data transmission inhibited maker 608. When determination is made that transmission is allowed, CPU 42 searches in storage device 45 for administration entrustment specification data 400A corresponding to mask design data 300. That administration entrustment specification data 400A is read out and written into RAM 43. CPU 42 instructs input/output interface device 41 to transmit a notification of a purchase application of mask design data 300 as well as purchase request specification data 700 to design maker terminal 11 of design maker A that is the storage source maker. Input/output interface device 41 transmits the notification and purchase request specification data 700 to design maker 11 via network 5.

CPU 42 provides purchase request specification data 700 to storage device 45. Storage device 45 stores purchase request specification data 700 into the purchase request specification table.

The series of the process flow from administration entrustment of mask design data 300 to sales of mask design data 300 according to the second embodiment will be described hereinafter.

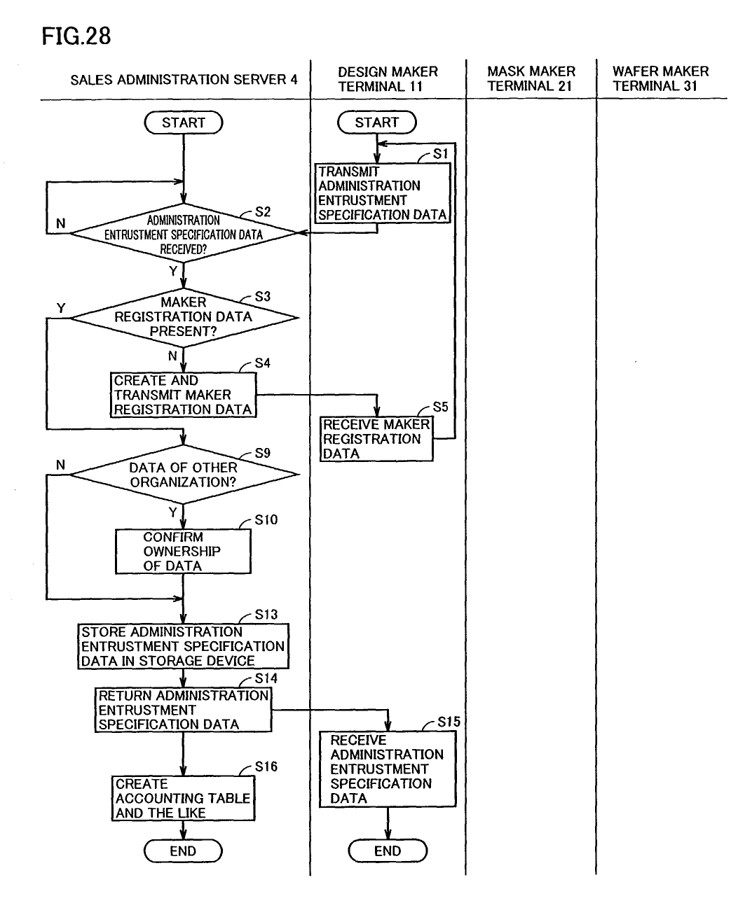

FIG. 28 is a flow chart of the process carried out when design maker A entrusts administration of mask design data 300 to sales administration server 4 from design maker terminal 11.

The processing flow of FIG. 28 is absent of steps S6-S8 and steps S11 and S12 carried out in the process flow shown in FIG. 18 in the previous first embodiment. This is because the process of storing the storage contract related to mask design data 300 as well as mask design data 300 into storage device 45 is not required since mask design data 300 is not stored at sales administration server 4.

The remaining processes are similar to those of the first embodiment, and description thereof will not be repeated.

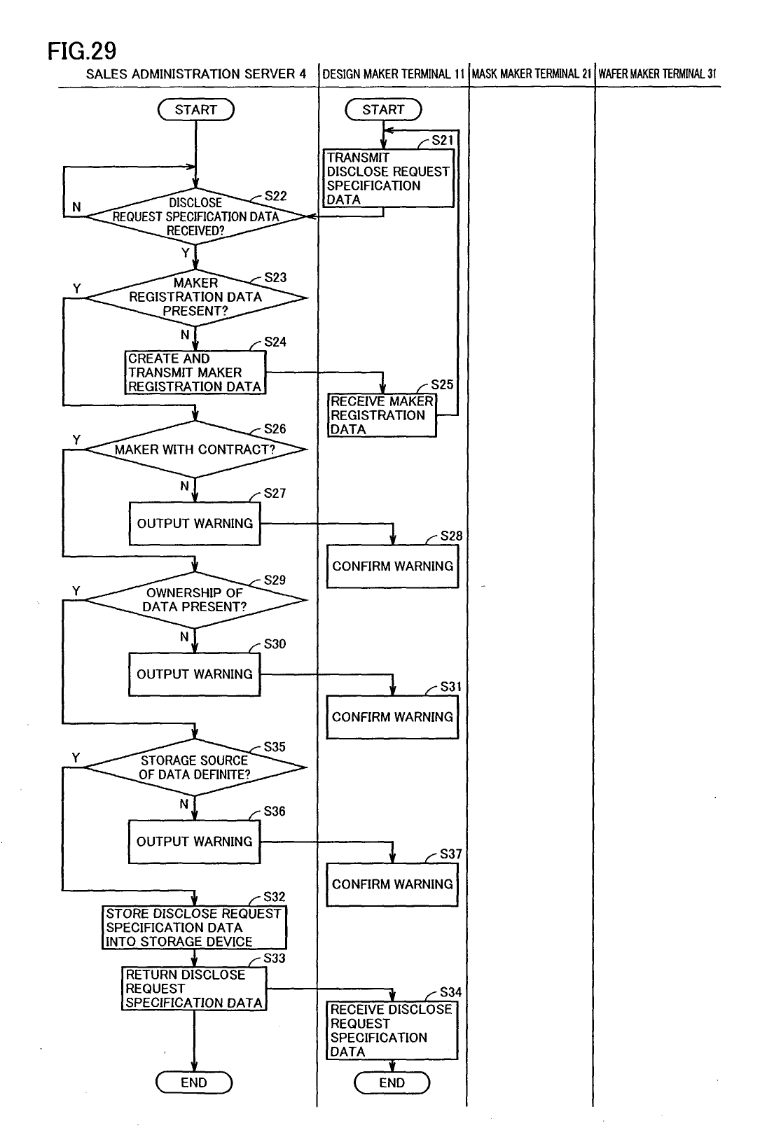

FIG. 29 is a flow chart of the process carried out when design maker A entrusts disclosure of specification information on mask design data 300 that is the subject of administration entrustment to sales administration server 4 from design maker terminal 11.

The process flow of FIG. 29 additionally includes steps S35-S37 with respect to the process flow of FIG. 19 described in the first embodiment. In the second embodiment, sales administration server 4 does not store mask design data 300. The storage source of mask design data 300 is indicated in administration entrustment specification data 400A. Prior to entrustment of disclosure of specification information leading to the purchase of mask design data 300, sales administration server 4 must confirm the storage source of mask design data 300.

The additional steps S35 to S37 will be described here. When determination is made that design maker A possesses the ownership of mask design data 300 at step S29, sales administration server 4 obtains the maker code of storage source code 414 in administration entrustment specification data 400A to check the presence of maker registration data 200 corresponding to the maker code specified as storage source code 414, and checks whether the storage source maker of mask design data 300 is designated or not (step S35).

When the storage source maker cannot be identified, sales administration server 4 transmits warning data indicating that the disclosure entrustment request is unaccepted to design maker terminal 11 via network 5 (step S36). Design maker A confirms the warning data at design maker terminal 11 (step S37), and confirms whether the storage source maker (design maker A in this case) is designated in storage source code 414.

When the storage source maker is identified at step S35, control proceeds to step S32.

The remaining processes are similar to those of the first embodiment, and description thereof will not be repeated.

The process flow as to disclosure of the specification information related to mask design data 300 in the second embodiment is similar to the process flow of FIG. 20 described in the first embodiment. Therefore, description thereof will not be repeated.

The processing flow of a sales entrustment of mask design data 300 in the second embodiment is similar to the process flow of FIG. 21 in the first embodiment. Therefore, description thereof will not be repeated.

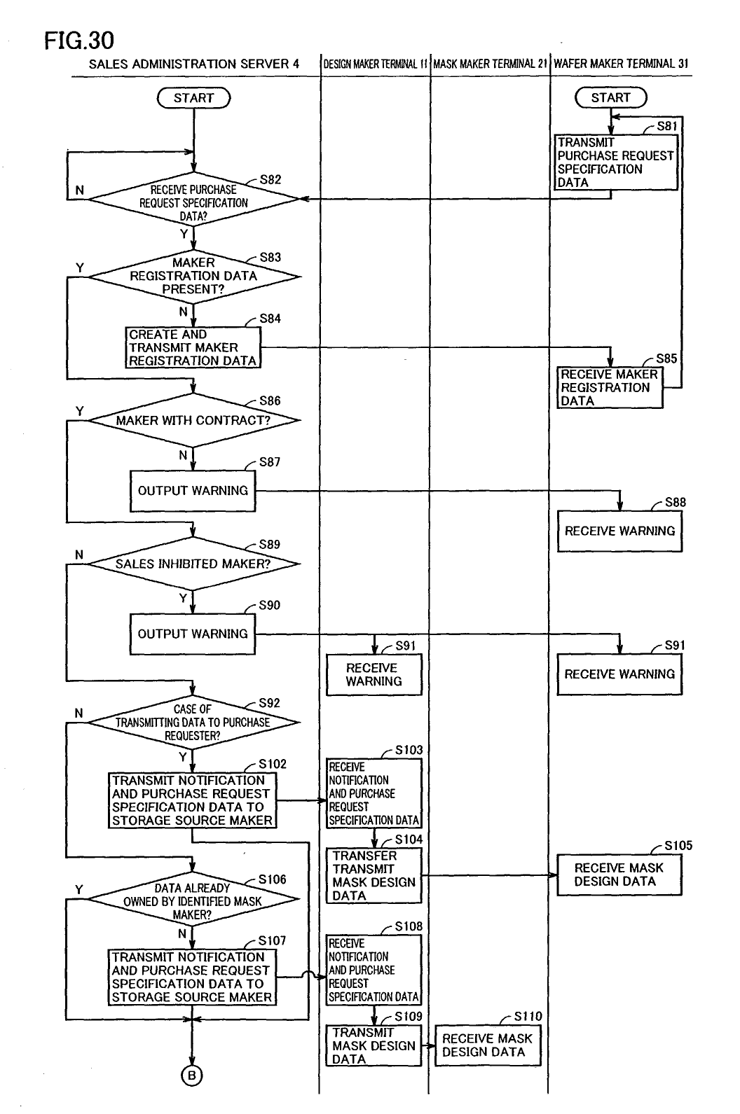

FIGS. 30 and 32 are flow charts of the process carried out when sales administration server 4 is to sell mask design data 300 to wafer maker terminal 31.

The process flow of FIG. 30 includes a series of steps S102 to S110 instead of steps S93 to S97 in the process flow of FIG. 21 described in the first embodiment. In contrast to the previous first embodiment in which sales administration server 4 retains mask design data 300, mask design data 300 is stored at the storage source maker indicated in administration entrustment specification data 400A in the second embodiment. Therefore, the process related to transmission of mask design data 300 differs.

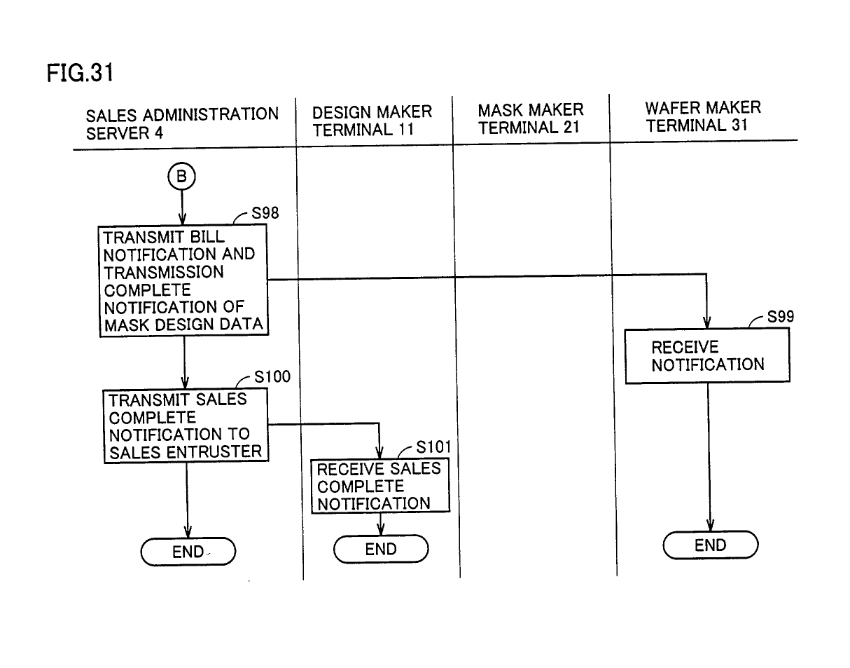

Steps S102 to S110 will be described hereinafter. When determination is made at step S92 that the maker code of transmission destination 709 matches the maker code of purchase requester code 705 so that mask design data 300 is to be transmitted to wafer maker terminal 31, sales administration server 4 transmits a notification of a purchase application of mask design data 300 as well as purchase request specification data 700 to design maker terminal 11 of design maker A that is the storage source maker based on the maker code indicated in storage source code 414 in administration entrustment specification data 400A (step S102). Then, control proceeds to step S98 of FIG. 31.

Upon receiving a purchase apply notification and purchase request specification data 700 from sales administration server 4 via network 5 (step S103), design maker terminal 11 transmits mask design data 300 to wafer maker terminal 31 via network 5 (step S104). Wafer maker terminal 31 receives the relevant mask design data 300 (step S105).

When determination is made that the maker code of transmission destination 709 does not match the maker code of purchase requester code 705 so that mask design data 300 is not to be transmitted to wafer maker terminal 31 at step S92, sales administration server 4 determines that this is the case where mask design data 300 is to be transmitted to mask maker A that is the identified mask maker specified as transmission destination 709.

Sales administration server 4 compares the maker code of transmission destination 709 with the maker code of administration entruster code 403 in administration entrustment specification data 400A corresponding to mask design data 300 that is the subject of purchase to identify whether the administration entrustment of mask design data 300 has been issued from the identified mask maker specified as transmission destination 709. In other words, sales administration server 4 confirms whether mask maker A specified as transmission destination 709 already possesses mask design data 300 that is the subject of purchase (step S106).

When determination is made that mask maker A that is the identified mask maker already possesses mask design data 300, mask design data 300 does not have to be transmitted to mask maker terminal 21 specified as transmission destination 709. Therefore, control proceeds to step S98 of FIG. 31.

When determination is made that mask maker A that is the identified maker does not possess mask design data 300 at step S106, sales administration server 4 transmits a notification of a purchase application of mask design data 300 as well as purchase request specification data 700 to design maker terminal 11 of design maker A that is the storage source maker based on the maker code in storage source code 414 included in administration entrustment specification data 400A (step S107). Then, control proceeds to step S98 of FIG. 31.

Upon receipt of a purchase apply notification and purchase request specification data 700 from sales administration server 4 via network 5 (step S108), design maker terminal 11 transmits mask design data 300 to mask maker terminal 21 of mask maker A specified as transmission destination 709 via network 5 (step 5109). Mask maker terminal 21 receives mask design data 300 purchased by wafer maker A from design maker terminal 11 (step S110).

The other processes are similar to those described in the previous first embodiment. Therefore, description thereof will not be repeated.

Thus, the sales of mask design data 300 from design maker A to wafer maker A is carried out.

The above-described process flow is based on the case where mask design data 300 is transferred via network 5. However, mask design data 300 may be transferred through a recording medium with transmission medium 406 in administration entrustment specification data 400A or requested transmission medium 708 in purchase request specification data 700 specified as the recording medium.

Design maker A may entrust administration, disclosure and sales of mask design data 300 that has been designed and owned by itself and stored at mask maker A or mask maker B. In this case, design maker A sets the maker code of the storage source mask maker in storage source code 414 of administration entrustment specification data 400A.

The maker entrusting administration of mask design data 300 is not limited to design maker A, as in the first embodiment. The maker entrusting administration may be another design maker B that has purchased mask design data from design maker A to obtain the ownership of the mask design data, or other mask makers A or B or wafer makers A or B.

The maker requesting purchase of mask design data 300 is not limited to wafer maker A, as in the first embodiment. Another wafer maker B or mask makers A or B or even design maker B may request purchase of mask design data 300.

The maker entrusting disclosure of specification information related to mask design data 300 may differ from the maker entrusting administration of mask design data 300, similarly as described in the first embodiment.

Also, the maker entrusting sales of mask design data 300 may differ from the maker entrusting administration of mask design data 300, similarly as in the first embodiment.

In the second embodiment, the terminal that effects administration entrustment, disclosure entrustment, sales entrustment, disclose request, and purchase request of mask design data 300 designed by design maker A is as shown in FIG. 25 in mask design data sales system 100.

According to the second embodiment, the sales of mask design data is mediated based on administration entrustment specification data 400A, disclosure entrustment specification data 500 and sales entrustment specification data 600 received from the terminal of the maker that has entrusted administration, sales and disclosure of mask design data, and purchase request specification data 700 received from the terminal of a maker that wishes to purchase mask design data in the second embodiment. Therefore, the tedious procedure for sales is eliminated. The cost and time required for the sales procedure can be suppressed.

Disclosure of the specification information related to mask design data can be limited as desired by the maker entrusting disclosure of the specification information related to the mask design data. Also, the organization to which mask design data is sold can be restricted as desired by the maker entrusting sales of mask design data. Therefore, each maker can prevent outflow of the know-how related to the mask design data to a competent maker.

Since the sales commission fee is lowered according to the number of sales of mask design data which is the subject of administration entrustment, acceptance of more mask design data administration entrustments is promoted. The administrator carrying out administration of mask design data can collect more sales commission fee in accordance with the increase of the number of sales due to the increase of the mask design data to be administered.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A sales method of receiving a sales entrustment of mask design data of a photomask and selling said mask design data to a purchase-requesting maker that wishes to purchase said mask design data through a computer system, comprising:
a step of registering said purchase-requesting maker on maker registration data,
a step of determining whether said purchase-requesting maker satisfies a disclosure condition of specification information related to said photomask according to a disclose request of said specification information received from a terminal of said purchase-requesting maker,
a step of transmitting said specification information to said terminal of said purchase-requesting maker when determination is made that said specification information can be disclosed to said purchase-requesting maker based on said determination result,
a step of receiving purchase request specification data that requests purchase of said mask design data from said terminal of said purchase-requesting maker, and
a step of transmitting said mask design data to a terminal determined based on said purchase request specification data.

2. The sales method according to claim 1, wherein said disclosure condition comprises a first condition and a second condition,
said first condition being that said purchase-requesting maker is registered in said maker registration data, and
said second condition being that said purchase-requesting maker does not correspond to a maker inhibited of disclosure of said specification information.

3. The sales method according to claim 1, further comprising:
a step of receiving administration entrustment specification data entrusting administration of said mask design data from a terminal of a sales-entrusting maker that entrusts sales of said mask design data, and
a step of receiving said mask design data under administration entrustment specified in said administration entrustment specification data from said terminal of said sales-entrusting maker and storing the same,
wherein said stored mask design data is transmitted in said step of transmitting said mask design data to a terminal determined based on said purchase request specification data.

4. The sales method according to claim 3, further comprising a step of receiving from said terminal of said sales-entrusting maker disclosure entrustment specification data including said specification information and said disclosure condition,
wherein said determination is made based on said disclosure condition in said received disclosure entrustment specification data in said step of determining whether said purchase-requesting maker satisfies a disclosure condition of said specification information.

5. The sales method according to claim 3, further comprising a step of determining a storage fee of said mask design data for said sales-entrusting maker according to a storing size of said mask design data received from said terminal of said sales-entrusting maker.

6. The sales method according to claim 3, wherein said mask design data is transferred via a communication network or a recording medium at said step of receiving said mask design data under administration entrustment specified in said administration entrustment specification data from said terminal of said sales-entrusting maker and storing the same.

7. The sales method according to claim 1, further comprising a step of receiving administration entrustment specification data including storage source information indicating a storage source of said mask design data from a terminal of a sale-entrusting maker that entrusts sales of said mask design data,
wherein a notification of a purchase application of said mask design data is made to a terminal of a storage source maker of said mask design data identified by said storage source information, and said mask design data is transmitted from said terminal of said storage source maker according to said notification at said step of transmitting said mask design data to a terminal determined based on said purchase request specification data.

8. The sales method according to claim 7, further comprising a step of receiving disclosure entrustment specification data including said specification information and said disclosure condition from said terminal of said sales-entrusting maker,
wherein said determination is made based on said disclosure condition in said received disclosure entrustment specification data at said step of determining whether said purchase-requesting maker satisfies a disclosure condition of said specification information.

9. The sales method according to claim 1, further comprising a step of determining whether said purchase-requesting maker satisfies a sales condition of said data design data according to receipt of said purchase request specification data from said terminal of said purchase-requesting maker,
wherein said mask design data is transmitted at said step of transmitting said mask design data to a terminal determined based on said purchase request specification data when determination is made that said mask design data can be sold to said purchase-requesting maker based on said determination result.

10. The sales method according to claim 9, wherein said sales condition comprises a first condition, a second condition, and a third condition,
said first condition being that said purchase-requesting maker is registered on said data registration data,
said second condition being that said purchase-requesting maker does not correspond to a maker inhibited of sales of said mask design data, and
said third condition being that said purchase-requesting maker does not correspond to a maker inhibited of transmission of said mask design data.

11. The sales method according to claim 9, further comprising:
a step of receiving administration entrustment specification data entrusting administration of said mask design data from a terminal of a sales-requesting maker requesting sales of said mask design data, and
a step of receiving said mask design data under administration entrustment specified in said administration entrustment specification data from said terminal of said sales-entrusting maker and storing the same,
wherein said stored mask design data is transmitted at said step of transmitting said mask design data to a terminal determined based on said purchase request specification data.

12. The sales method according to claim 11, further comprising a step of receiving sales entrustment specification data including said sales condition from said terminal of said sales-entrusting maker,
wherein said determination is made based on said sales condition in said received sales entrustment specification data at said step of determining whether said purchase-requesting maker satisfies a sales condition of said data design data according to receipt of said purchase request specification data from said terminal of said purchase-requesting maker.

13. The sales method according to claim 1, wherein said mask design data is transmitted to a terminal of a maker specified by transmission destination information included in said purchase request specification data at said step of transmitting said mask design data to a terminal determined based on said purchase request specification data.

14. The sales method according to claim 13, wherein said mask design data is transmitted to a terminal of a mask maker that fabricates photomasks, specified by the transmission destination information included in said purchase request specification data.

15. The sales method according to claim 1, wherein specification data selected from said specification information is transmitted to said terminal of said purchase-requesting maker according to a disclosure level preset with respect to each specification data included in said specification information at said step of transmitting said specification information to said terminal of said purchase-requesting maker when determination is made that said specification information can be disclosed to said purchase-requesting maker.

16. The sales method according to claim 1, further comprising a step of determining a sales commission fee of said mask design data for a maker entrusting sales of said mask design data according to a sales past record of said mask design data under sales entrustment.

17. The sales method according to claim 1, wherein said mask design data is transferred via a communication network or a recording medium at said step of transmitting said mask design data to a terminal determined based on said purchase request specification data.
